(19) United States
(12) Patent Application Publication
(10) Pub. No.: US 2024/0419932 A1
(43) Pub. Date: Dec. 19, 2024

(54) STORAGE DEVICE

(71) Applicant: SAMSUNG ELECTRONICS CO., LTD., Suwon-si (KR)

(72) Inventor: Youngwoo PARK, Suwon-si (KR)

(73) Assignee: SAMSUNG ELECTRONICS CO., LTD., Suwon-si (KR)

(21) Appl. No.: 18/739,968

(22) Filed: Jun. 11, 2024

(30) Foreign Application Priority Data
Jun. 13, 2023 (KR) 10-2023-0075548

(51) Int. Cl. G06K 19/077; G06F 13/38

(52) U.S. Cl. CPC G06K 19/07732; G06F 13/385; G06K 19/07743; G06K 19/07745

(57) ABSTRACT

A storage device includes a storage controller and a printed circuit board. The printed circuit board includes a host interface connector including first pins coupled to an external host device, a controller socket in which the storage controller is mounted, and a first slot that may receive a first secure digital (SD) Express device, the first slot including second pins to be coupled to the first SD Express device. A first receive pin among the first pins is connected to a first receive pin among the second pins, a second receive pin among the first pins is connected to a second receive pin among the second pins, a first transmit pin among the first pins is connected to a first transmit pin among the second pins, and a second transmit pin among the first pins is connected to a second transmit pin among the second pins.

### CROSS-REFERENCE TO RELATED APPLICATION

This application is based on and claims priority under 35 U.S.C. § 119 to Korean Patent Application No. 10-2023-0075548, filed on Jun. 13, 2023, in the Korean Intellectual Property Office, the disclosure of which being incorporated by reference herein in its entirety.

### BACKGROUND

Apparatuses and devices consistent with the present disclosure relate to a semiconductor memory, and more particularly, to a storage device including a detachable secure digital (SD) Express device.

Semiconductor memories are classified as volatile memory devices in which stored data is lost when the power supply thereto is cut off, such as static random access memory (SRAM) and dynamic RAM (DRAM), and non-volatile memory devices in which stored data is retained even when the power supply thereto is cut off, such as flash memory devices, phase-change RAM (PRAM), magneto-resistive RAM (MRAM), Resistive RAM (ReRAM), and ferroelectric RAM (FRAM).

Flash memory devices are widely used as mass storage media in computing systems. The SD card market is expanding and continues to grow with high capacity. However, there is a disadvantage in that it is difficult to use micro SD cards as high-capacity/high-speed devices.

### SUMMARY

It is an aspect to provide a storage device including a detachable secure digital (SD) Express device.

According to an aspect of one or more embodiments, there is provided a storage device comprising a storage controller; and a printed circuit board. The printed circuit board comprises a host interface connector comprising a plurality of first pins coupled to an external host device; a controller socket in which the storage controller is mounted; and a first slot configured to receive a first secure digital (SD) Express device, the first slot comprising a plurality of second pins to be coupled to the first SD Express device, wherein a first receive pin among the plurality of first pins is connected to a first receive pin among the plurality of second pins, a second receive pin among the plurality of first pins is connected to a second receive pin among the plurality of second pins, a first transmit pin among the plurality of first pins is connected to a first transmit pin among the plurality of second pins, and a second transmit pin among the plurality of first pins is connected to a second transmit pin among the plurality of second pins.

According to another aspect of one or more embodiments, there is provided a storage device comprising a storage controller; a host interface connector comprising a plurality of first pins coupled to an external host device; a first slot configured to receive a first secure digital (SD) Express device, the first slot comprising a plurality of second pins to be coupled to the first SD Express device; a first signal line configured to connect a first receive pin among the plurality of first pins to a first receive pin among the plurality of second pins; a second signal line configured to connect a second receive pin among the plurality of first pins to a second receive pin among the plurality of second pins; a third signal line configured to connect a first transmit pin among the plurality of first pins to a first transmit pin among the plurality of second pins; and a fourth signal line configured to connect a second transmit pin among the plurality of first pins to a second transmit pin among the plurality of second pins.

According to another aspect of one or more embodiments, there is provided a storage device comprising a storage controller; a first secure digital (SD) Express device; a second SD Express device; a non-volatile memory device; and a printed circuit board. The printed circuit board comprises a host interface connector comprising a plurality of first pins coupled to an external host device; a controller socket in which the storage controller is mounted; a memory socket in which the non-volatile memory device is mounted; a first slot in which the first SD Express device is mounted, the first slot comprising a plurality of second pins coupled to the first SD Express device; and a second slot in which the second SD Express device is mounted, the second slot comprising a plurality of third pins coupled to the second SD Express device. A first receive pin among the plurality of first pins is connected to a first receive pin among the plurality of second pins, a second receive pin among the plurality of first pins is connected to a second receive pin among the plurality of second pins, a first transmit pin among the plurality of first pins is connected to a first transmit pin among the plurality of second pins, a second transmit pin among the plurality of first pins is connected to a second transmit pin among the plurality of second pins, a third receive pin among the plurality of first pins is connected to a first receive pin among the plurality of third pins, a fourth receive pin among the plurality of first pins is connected to a second receive pin among the plurality of third pins, a third transmit pin among the plurality of first pins is connected to a first transmit pin among the plurality of third pins, and a fourth transmit pin among the plurality of first pins is connected to a second transmit pin among the plurality of third pins.

### BRIEF DESCRIPTION OF THE DRAWINGS

Various embodiments will be more clearly understood from the following detailed description taken in conjunction with the accompanying drawings, in which:

FIG. 1 is a block diagram illustrating a storage system according to an embodiment;

FIG. 2 is a block diagram illustrating a storage device according to an embodiment;

FIG. 3 is a block diagram illustrating a first secure digital (SD) Express device according to an embodiment;

FIG. 4 is a diagram for explaining a form factor of a micro SD Express card;

FIGS. 5A and 5B are diagrams illustrating a storage device according to an embodiment;

FIG. 6 is a diagram illustrating a storage device according to an embodiment;

FIGS. 7A to 7C are diagrams illustrating printed circuit boards according to an embodiment;

FIG. 8 is a diagram illustrating a storage device according to an embodiment;

FIG. 9 is a diagram illustrating a storage device according to an embodiment;

FIG. 10 is a block diagram illustrating a storage device according to an embodiment;

FIG. 11 is a block diagram illustrating a storage device according to an embodiment.

FIG. 12 is a block diagram illustrating a storage device according to an embodiment;

FIGS. 13A and 13B are block diagrams illustrating storage devices according to an embodiment;

FIG. 14 is a flowchart illustrating an operating method of a storage system according to an embodiment.

FIG. 15 is a flowchart illustrating an operating method of a storage system according to an embodiment; and

FIG. 16 is a block diagram illustrating an electronic device according to an embodiment.

### DETAILED DESCRIPTION

Recently, various technologies for supporting the high-speed operation of flash memory devices have been developed. As an example, an SD Express interface defined according to the SD standard may support a higher operating speed than that of the SD card of the related art. The SD Express interface uses Peripheral Component Interconnect Express (PCIe) lanes and is implemented according to a Non-Volatile Memory (NVM) Express protocol.

Hereinafter, various embodiments will be described clearly and in detail to the extent that those of ordinary skill in the art may easily practice the embodiments.

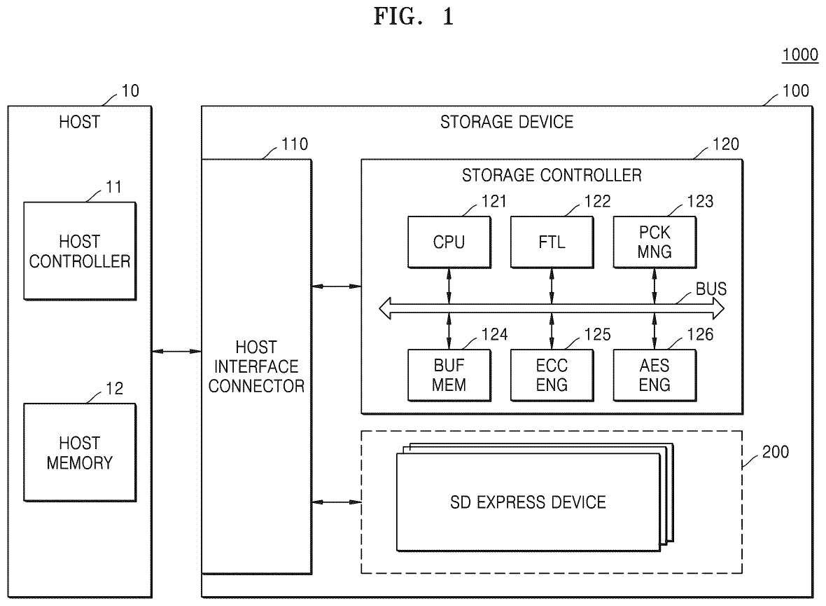

FIG. 1 is a block diagram illustrating a storage system 1000 according to an embodiment.

Referring to FIG. 1, the storage system 1000 may include a host 10 and a storage device 100. In an embodiment, the storage system 1000 may be one of information processing devices configured to process various information and store the processed information. For example, in some embodiments, the storage system 1000 may be a personal computer (PC), a laptop, a server, a workstation, a smart phone, a tablet PC, a digital camera, a black box, etc.

The host 10 may control overall operations of the storage system 1000. For example, the host 10 may transmit a request to the storage device 100 to store data in the storage device 100 or to read the data stored in the storage device 100. In an embodiment, the host 10 may be a processor core such as a central processing unit (CPU) and an application processor (AP) configured to control the storage system 1000, or a computing node connected over a network.

In an embodiment, the host 10 may include a host controller 11 and a host memory 12. The host controller 11 may be a device configured to control overall operations of the host 10 or to control the storage device 100 at the side of the host 10. The host memory 12 may be a buffer memory, a cache memory, or a working memory used in the host 10. An application program, a file system, a device driver, etc. may be loaded on the host memory 12. Various software or data driven in the host 10 may be loaded on the host memory 12.

According to an embodiment, the host controller 11 and the host memory 12 may be implemented as separate semiconductor chips. In some embodiments, the host controller 11 and the host memory 12 may be integrated in the same semiconductor chip. As an example, in some embodiments, the host controller 11 may be any one of a plurality of modules included in an application processor, and the application processor may be implemented as a system on chip (SoC). In some embodiments, the host memory 12 may be an embedded memory included in the application processor, or may be a non-volatile memory (NVM) or a memory module disposed outside the application processor.

The host controller 11 may manage an operation of storing data (e.g., write data) in a buffer region of the host memory 12 in a plurality of SD Express devices 200, or storing data (e.g., write data) of the plurality of SD Express devices 200 in the buffer region.

The storage device 100 may operate under the control of the host 10. The storage device 100 may include a host interface connector 110, a storage controller 120, a plurality of sockets (not shown), and the plurality of SD Express devices 200. In an embodiment, each of the plurality of SD Express devices 200 may follow the micro SD Express card standard. In an embodiment, the storage device 100 may include only the plurality of SD Express devices 200. In an embodiment, the storage device 100 may include both the plurality of SD Express devices 200 and a plurality of NVM devices.

The storage device 100 may include storage media storing data according to a request from the host 10. As an example, the storage device 100 may be at least one of a solid state drive (SSD), an embedded memory, or a detachable external memory. When the storage device 100 is an SSD, the storage device 100 may be a device conforming to the NVM Express (NVMe) standard. When the storage device 100 is an embedded memory or an external memory, the storage device 100 may be a device conforming to SD Express (universal flash storage) or embedded multi-media card (eMMC) standard. The host 10 and the storage device 100 may respectively generate and transmit packets according to adopted standard protocols.

The storage device 100 may include a detachable external memory. In particular, the storage device 100 may include the plurality of detachable SD Express devices 200. When each of the plurality of SD Express devices 200 includes a flash memory, the flash memory may include a 2D NAND memory array or a 3D (or vertical) NAND (VNAND) memory array.

In an embodiment, the storage device 100 may include other various types of NVM devices. For example, magnetic RAM (MRAM), spin-transfer torque MRAM, conductive bridging RAM (CBRAM), ferroelectric RAM (FeRAM), phase RAM (PRAM), resistive memory, and other various types of memories may be applied to the storage device 100.

The host interface connector 110 may include a plurality of pins. The host interface connector 110 may be coupled or connected to the host 10. The host interface connector 110 may be implemented based on a U.2 form factor, an M.2 form factor, or a Peripheral Component Interconnect Express (PCIe)-based form factor. In some embodiments, the host interface connector 110 may be implemented based on one or more of a U.2 form factor, an M.2 form factor, or a Peripheral Component Interconnect Express (PCIe)-based form factor. The storage device 100 may include a host interface circuit (not shown). The host interface circuit may communicate with the host 10 based on a predefined interface protocol. The host interface circuit may be implemented based on the predefined interface protocol. In an embodiment, the predefined interface protocol may include at least one of various interfaces such as a PCIe interface and an NVMe interface.

The storage controller 120 may store data in the plurality of SD Express devices 200 or NVM devices under the control of the host 10. The storage controller 120 may read the data stored in the plurality of SD Express devices 200 or the NVM devices. In an embodiment, the storage controller 120 may perform various management operations for efficiently using the plurality of SD Express devices 200.

In an embodiment, the storage controller 120 may control the plurality of SD Express devices 200. The storage controller 120 may generate and update device status information of the plurality of SD Express devices 200. The storage controller 120 may perform an initialization operation on the plurality of SD Express devices 200. The storage controller 120 may transmit an identification command and receive a response in order to recognize device information of the plurality of SD Express devices 200. The storage controller 120 may determine whether a slot corresponding to each of the plurality of SD Express devices 200 has an SD Express device mounted thereto or removed therefrom and recognize whether the slot has a corresponding SD Express device mounted or removed.

The storage controller 120 may include a central processing unit (CPU) 121, a flash translation layer (FTL) 122, a packet manager (PCK MNG) 123, a buffer memory (BUF MEM) 124, an error correction code (ECC) engine (ENG) 125, and an advanced encryption standard (AES) engine (ENG) 126. The storage controller 120 may further include a working memory (not shown) into which the FTL 122 is loaded, and may control a data write and read operation on the plurality of SD Express devices 200 or the NVM devices by the CPU 121 executing the FTL 122. The storage controller 120 may be configured to control the plurality of detachable SD Express devices 200. The storage controller 120 may be configured to control the NVM devices.

The CPU 121 may control overall operations of the storage controller 120. The FTL 122 may perform various operations for efficiently using the plurality of SD Express devices 200 or the NVM devices. The FTL 122 may perform various functions such as address mapping, wear-leveling, and garbage collection.

Address mapping is an operation of changing a logical address received from the host 10 to a physical address used to actually store data in the NVM devices or the plurality of SD Express devices 200. Wear-leveling is a technique for preventing excessive deterioration of a specific block by uniformly using blocks in the NVM devices or the plurality of SD Express devices 200, and, for example, may be implemented through a firmware technique for balancing erase counts of physical blocks. Garbage collection is a technique for securing usable capacity in the NVM devices or the plurality of SD Express devices 200 by copying valid data of a block to a new block and then erasing the old block.

The packet manager (PCK MNG) 123 may generate a packet according to an interface protocol negotiated with the host 10 or parse various types of information from a packet received from the host 10. The buffer memory (BUF MEM) 124 may temporarily store data to be written to the NVM devices or the plurality of SD Express devices 200 or data to be read from the NVM devices or the plurality of SD Express devices 200. The buffer memory 124 may be included in the storage controller 120, but in some embodiments, may be disposed outside the storage controller 120.

The ECC engine (ENG) 125 may perform error detection and correction functions with respect to read data read from the NVM devices or the plurality of SD Express devices 200. More specifically, the ECC engine 125 may generate parity bits with respect to write data to be written in the NVM devices or the plurality of SD Express devices 200, and the generated parity bits may be stored in the NVM devices or the plurality of SD Express devices 200 together with the write data. When reading data from the NVM devices or the plurality of SD Express devices 200, the ECC engine 125 may correct an error of the read data by using the parity bits read from the NVM devices or the plurality of SD Express devices 200 together with the read data, and output the read data in which the error is corrected.

The AES engine (ENG) 126 may perform at least one of an encryption operation or a decryption operation on data input to the storage controller 120 by using a symmetric-key algorithm.

The storage device 100 may include the plurality of detachable SD Express devices 200 instead of an embedded or built-in memory. Accordingly, the size of a storage space of the storage device 100 may be variable. For example, when the storage device 100 includes no SD Express device (i.e., when all SD Express devices are separated from the storage device 100), the size of the storage space of the storage device 100 may be minimum. As a new SD Express device is mounted in the storage device 100, the size of the storage space of the storage device 100 may increase. When the storage device 100 includes the maximum possible SD Express device, the size of the storage space of the storage device 100 may be maximum.

In an embodiment, the storage device 100 may determine a state in which SD Express devices are mounted or removed during an initialization process. The storage device 100 may generate device status information based on the state in which SD Express devices are mounted or removed. The storage device 100 may transmit device status information to the host 10.

In an embodiment, the storage device 100 may notify the host 10 of an event in which an SD Express device is inserted or removed or an event in which the size of the storage space of the storage device 100 is changed. For example, when a new SD Express device is inserted, the storage device 100 may notify the host 10 of whether the new SD Express device is inserted and the increased size of the storage space. That is, the storage device 100 may notify the host 10 of device status information through an asynchronous event request.

For example, the device status information may include information about the state of the SD Express device and information about the size of the storage space. The information about the state of the SD Express device may include information about the number of SD Express devices installed in the storage device 100, information about slots into which mounted SD Express devices are inserted, information about a newly mounted or removed SD Express device, etc. The information about the size of the storage space may include the increased size of the storage space when the SD Express device is inserted, the reduced size of the storage space when the SD Express device is removed, the total size of the storage space, and/or the size of storage space of each of the SD Express devices, etc.

In an embodiment, the storage device 100 may transmit the device status information to the host 10. For example, the storage device 100 may update the device status information in a log when a new SD Express device is mounted. The storage device 100 may transmit completion of the asynchronous event request to the host 10. The host 10 may transmit a Get Log Page request to the storage device 100 in response to the completion of the asynchronous event request. The storage device 100 may receive the Get Log Page request The storage device 100 may transmit log data including the device status information and completion of Get Log Page to the host 10 in response to the Get Log Page request.

As described above, the storage device 10 according to an embodiment may include a plurality of detachable SD Express devices. According to required speed and storage capacity, the number of SD Express devices mounted on the storage device 100 and conforming to the micro SD card standard may vary. As the number of mounted micro SD Express devices increases, the number of PCIe lanes used for the host interface connector 110 may increase. As the number of usable PCIe lanes increases, the speed of the storage device 100 may increase. Configurations and effects according to some embodiments are described in more detail with reference to the following drawings.

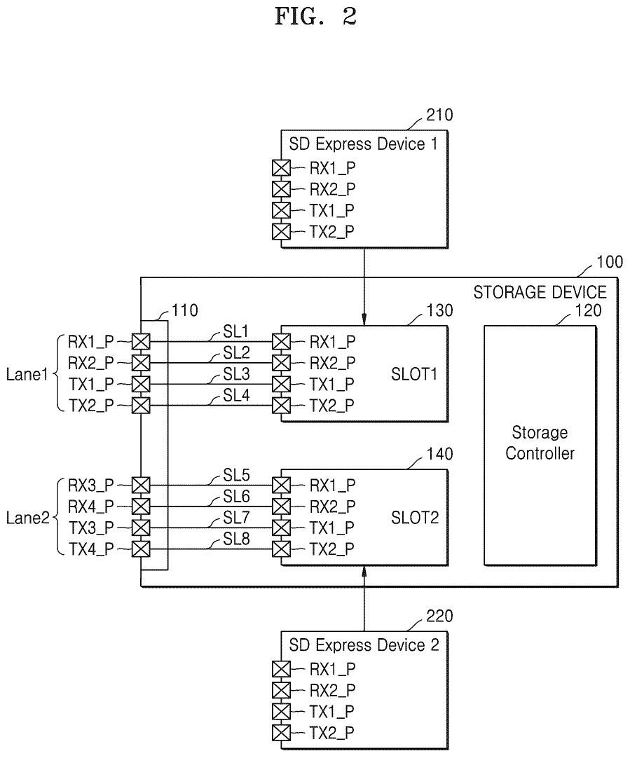

FIG. 2 is a block diagram illustrating the storage device 100 according to an embodiment.

Referring to FIG. 2, the storage device 100 may include a host interface connector 110, a storage controller 120, a first slot 130, and a second slot 140. In some embodiments, the storage device 100 may further include a first SD Express device 210 and a second SD Express device 220.

The host interface connector 110 may include a plurality of first pins. For example, the plurality of first pins include a first receive pin RX1_P, a second receive pin RX2_P, a third receive pin RX3_P, a fourth receive pin RX4_P, a first transmit pin TX1_P, a second transmit pin TX2_P, a third transmit pin TX3_P, and a fourth transmit pin TX4_P. However, the scope of the present disclosure is not limited thereto, and in some embodiments, the plurality of first pins may further include additional pins, such as, for example, a power voltage pin, a ground pin, etc.

The host interface connector 110 may support multiple lanes, and each lane may be implemented as a differential line pair. For example, the host interface connector 110 may include pins connected to one or more receive lanes and pins connected to one or more transmit lanes. A pair of lines (i.e., two lines) transmitting a pair of differential input signals RX+ and RX− may constitute a receive lane, and a pair of lines (i.e., two lines) transmitting a pair of differential output signals TX+ and TX− may constitute a transmit lane.

For example, the first receive pin RX1_P may receive the first differential input signal RX+, the second receive pin RX2_P may receive the second differential input signal RX−, the first transmit pin TX1_P may transmit the first differential output signal TX+, and the second transmit pin TX2_P may transmit the second differential output signal TX−. The third receive pin RX3_P may receive the first differential input signal RX+, the fourth receive pin RX4_P may receive the second differential input signal RX−, the third transmit pin TX3_P may transmit the first differential output signal TX+, and the fourth transmit pin TX4_P may transmit the second differential output signal TX−.

Among the plurality of first pins, the first receive pin RX1_P, the second receive pin RX2_P, the first transmit pin TX1_P, and the second transmit pin TX2_P may form a first lane. Among the plurality of first pins, the third receive pin RX3_P, the fourth receive pin RX4_P, the third transmit pin TX3_P, and the fourth transmit pin TX4_P may form a second lane. Although two lanes are shown in FIG. 2, the number of lanes may be changed according to various embodiments.

A first SD Express device 210 may be mounted in the first slot 130. The first slot 130 may include a plurality of second pins. The first slot 130 may include the plurality of second pins to be coupled to the first SD Express device 210 when the first SD Express device 210 is received in the first slot 130. For example, the first slot 130 may include the first receive pin RX1_P, the second receive pin RX2_P, the first transmit pin TX1_P, and the second transmit pin TX2_P.

The first receive pin RX1_P among the plurality of second pins may be connected to the first receive pin RX1_P among the plurality of first pins. The second receive pin RX2_P among the plurality of second pins may be connected to the second receive pin RX2_P among the plurality of first pins. The first transmit pin TX1_P among the plurality of second pins may be connected to the first transmit pin TX1_P among the plurality of first pins. The second transmit pin TX2_P among the plurality of second pins may be connected to the second transmit pin TX2_P among the plurality of first pins.

The first SD Express device 210 may be mounted in the first slot 130. The first SD Express device 210 may include a plurality of third pins. The first SD Express device 210 may include the plurality of third pins to be coupled to the first slot 130 when the first SD Express device 210 is mounted in the first slot 130. For example, the plurality of third pins may include the first receive pin RX1_P, the second receive pin RX2_P, the first transmit pin TX1_P and the second transmit pin TX2_P.

The first receive pin RX1_P among the plurality of third pins may be coupled to the first receive pin RX1_P among the plurality of second pins. The second receive pin RX2_P among the plurality of third pins may be coupled to the second receive pin RX2_P among the plurality of second pins. The first transmit pin TX1_P among the plurality of third pins may be coupled to the first transmit pin TX1_P among the plurality of second pins. The second transmit pin TX2_P among the plurality of third pins may be coupled to the second transmit pin TX2_P among the plurality of second pins.

A second SD Express device 220 may be mounted in the second slot 140. The second slot 140 may include a plurality of fourth pins. The second slot 140 may include the plurality of fourth pins to be coupled to the second SD Express device 220 when the second SD Express device is mounted in the second slot 140. For example, the second slot 140 may include the first receive pin RX1_P, the second receive pin RX2_P, the first transmit pin TX1_P and the second transmit pin TX2_P.

The first receive pin RX1_P among the plurality of fourth pins may be connected to the third receive pin RX3_P among the plurality of first pins. The second receive pin RX2_P among the plurality of fourth pins may be connected to the fourth receive pin RX4_P among the plurality of first pins. The first transmit pin TX1_P among the plurality of fourth pins may be connected to the third transmit pin TX3_P among the plurality of first pins. The second transmit pin TX2_P of the plurality of fourth pins may be connected to the fourth transmit pin TX4_P of the plurality of first pins.

The second SD Express device 220 may be mounted in the second slot 140. The second SD Express device 220 may include a plurality of fifth pins. The second SD Express device 220 may include the plurality of fifth pins to be coupled to the second slot 140 when the second SD Express device 220 is mounted in the second slot 140. For example, the plurality of fifth pins may include the first receive pin RX1_P, the second receive pin RX2_P, the first transmit pin TX1_P, and the second transmit pin TX2_P.

The first receive pin RX1_P among the plurality of fifth pins may be coupled to the first receive pin RX1_P among the plurality of fourth pins. The second receive pin RX2_P among the plurality of fifth pins may be coupled to the second receive pin RX2_P among the plurality of fourth pins. The first transmit pin TX1_P among the plurality of fifth pins may be coupled to the first transmit pin TX1_P among the plurality of fourth pins. The second transmit pin TX2_P among the plurality of fifth pins may be coupled to the second transmit pin TX2_P among the plurality of fourth pins.

In an embodiment, the storage device 100 may further include first to eighth signal lines SL1 to SL8. The first signal line SL1 may connect the first receive pin RX1_P among the plurality of first pins to the first receive pin RX1_P among the plurality of second pins. The second signal line SL2 may connect the second receive pin RX2_P among the plurality of first pins to the second receive pin RX2_P among the plurality of second pins. The third signal line SL3 may connect the first transmit pin TX1_P among the plurality of first pins to the first transmit pin TX1_P among the plurality of second pins. The fourth signal line SL4 may connect the second transmit pin TX2_P among the plurality of first pins to the second transmit pin TX2_P among the plurality of second pins.

The fifth signal line SL5 may connect the third receive pin RX3_P among the plurality of first pins to the first receive pin RX1_P among the plurality of fourth pins. The sixth signal line SL6 may connect the fourth receive pin RX4_P among the plurality of first pins to the second receive pin RX2_P among the plurality of fourth pins. The seventh signal line SL7 may connect the third transmit pin TX3_P among the plurality of first pins to the first transmit pin TX1_P among the plurality of fourth pins. The eighth signal line SL8 may connect the fourth transmit pin TX4_P among the plurality of first pins to the second transmit pin TX2_P among the plurality of fourth pins.

As described above, some of the plurality of first pins of the host interface connector 110 may be connected to the first slot 130, and the others of the plurality of first pins of the host interface connector 110 may be connected to the second slot 140. The first SD Express device 210 mounted in the first slot 130 may directly communicate with the host 10 through the first to fourth signal lines SL1 to SL4. The second SD Express device 220 mounted in the second slot 140 may directly communicate with the host 10 through the fifth to eighth signal lines SL5 to SL8.

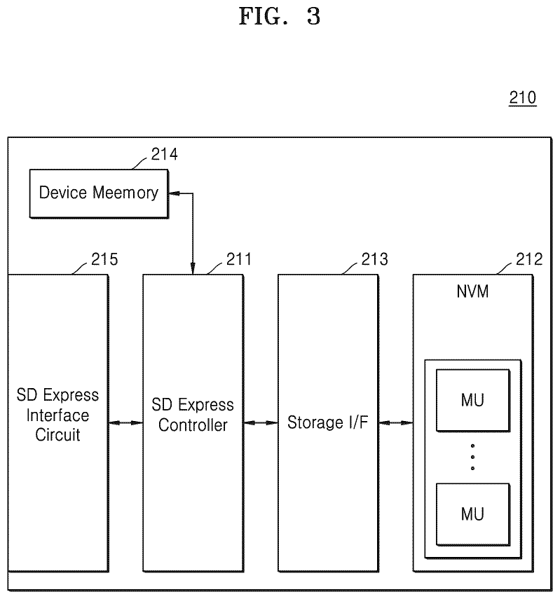

FIG. 3 is a block diagram illustrating the first SD Express device 210 according to an embodiment.

The plurality of SD Express devices 200 may communicate according to the SD Express standard. For brevity of the drawing and convenience of description, only the first SD Express device 210 among the plurality of SD Express devices 200 is shown in FIG. 3. Among the plurality of SD Express devices 200, the remaining SD Express devices except for the first SD Express device 210 are not illustrated in FIG. 3, but the following descriptions with respect to the first SD Express device 210 may be applied to the remaining SD Express devices and thus are omitted for conciseness.

Referring to FIGS. 1 and 3, the first SD Express device 210 may include an SD Express controller 211, an NVM 212, a storage interface (I/F) 213, a device memory 214, and an SD Express interface circuit 215. The NVM 212 may include a plurality of memory units (MUs) (or memory blocks), and the MU may include a 2D structure or a 3D structure V-NAND flash memory. However, embodiments are not limited thereto and, in some embodiments, the NVM 212 may include other types of non-volatile memories such as PRAM and/or RRAM. The SD Express controller 211 and the NVM 212 may be connected to each other through the storage interface 213. The storage interface 213 may be implemented to comply with a standard protocol such as Toggle or ONFI.

The SD Express controller 211 may control overall operations of the first SD Express device 210. The SD Express controller 211 may manage the NVM 212 through a logical unit (LU) (or logical page) that is a logical data storage unit. The SD Express controller 211 may include an FTL, and may convert a logical data address transmitted from the SD Express interface circuit 215, for example, a logical block address (LBA), into a physical data address, for example, a physical block address (PBA), by using address mapping information of the FTL. A logical block storing user data may have a size within a certain range. For example, the minimum size of the logical block may be set to 4 Kbyte.

When a request is input to the first SD Express device 210 through the SD Express interface circuit 215, the SD Express controller 211 may perform an operation according to the input request, and, when the operation is completed, transmit a completion response.

In an embodiment, when the host 10 writes user data in the first SD Express device 210, the host 10 may transmit a write request and the user data to the first SD Express device 210. The SD Express controller 211 may temporarily store the received user data in the device memory 214, and may store the user data temporarily stored in the device memory 214 in a selected location of the NVM 212 based on the address mapping information of the FTL.

In an embodiment, when the host 10 reads the user data stored in the first SD Express device 210, the host 10 may transmit a read request to the first SD Express device 210. Based on receiving the read request, the SD Express controller 211 may read the user data from the NVM 212 based on the read request and temporarily store the read user data in the device memory 214. During this reading process, the SD Express controller 211 may detect and correct an error in the read user data by using a built-in ECC engine (not shown). More specifically, the ECC engine may generate parity bits with respect to write data to be written in the NVM 212, and the generated parity bits may be stored in the NVM 212 together with the write data. When reading data from the NVM 212, the ECC engine may correct the error in the read data by using the parity bits read from the NVM 212 together with the read data, and output the read data in which the error is corrected.

The SD Express controller 211 may transmit the user data temporarily stored in the device memory 214 to the SD Express interface circuit 215. In addition, the SD Express controller 211 may further include an AES engine (not shown in FIG. 3). The AES engine may perform at least one of an encryption operation or a decryption operation on data input the SD Express controller 211 by using a symmetric-key algorithm.

Each of a plurality of MUs may include a memory cell array (not shown) and a control circuit (not shown) controlling an operation of the memory cell array. The memory cell array may include a 2D memory cell array or a 3D memory cell array. The memory cell array may include a plurality of memory cells, and each memory cell may be a single level cell (SLC) that stores information of 1 bit. However, embodiments are not limited thereto and, in some embodiments, each memory cell may be a cell that stores information of 2 bits or more, such as a multi level cell (MLC), a triple level cell (TLC), a quadruple level cell (QLC). The 3D memory cell array may include vertically oriented NAND strings such that at least one memory cell is located above another memory cell.

Referring to FIG. 2 together with FIG. 3, the SD Express interface circuit 215 may include one receive lane and one transmit lane. A pair of lines (i.e., two lines) receiving the pair of differential input signals RX+ and RX− may constitute a receive lane, and a pair of lines (i.e., two lines) transmitting the pair of differential output signals TX+ and TX− may constitute a transmit lane.

The receive lane and the transmit lane may receive and transmit data in a serial communication method, and full-duplex communication between the host 10 and the first SD Express device 210 is possible due to a structure in which the receive lane and the transmit lane are separated. That is, while receiving data from the host 10 through the receive lane, the first SD Express device 210 may transmit data to the host 10 through the transmit lane. Control data such as a request from the host 10 to the first SD Express device 210 and user data that the host 10 wants to store in the NVM 212 of the first SD Express device 210 or to read from the NVM 212 may be transmitted through the same lane. Accordingly, there is no need to provide a separate lane for data transmission between the host 10 and the first SD Express device 210 other than a pair of receive lanes and a pair of transmit lanes.

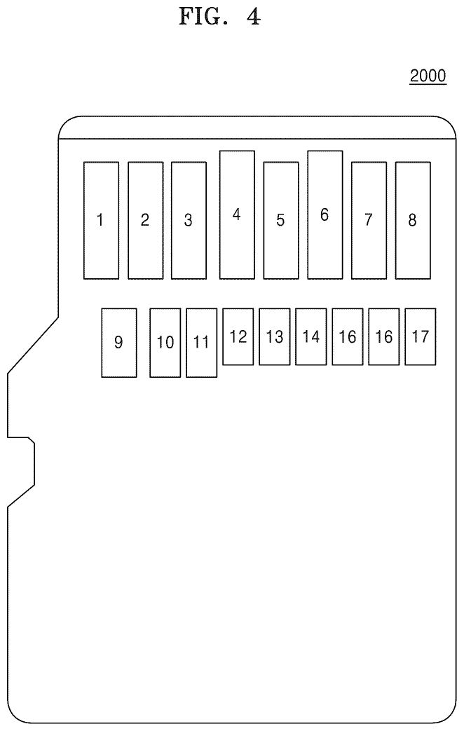

FIG. 4 is a diagram for explaining a form factor of a micro SD Express card 200.

When each of the plurality of SD Express devices 200 of FIG. 1 is implemented in the form of the micro SD Express card 2000, the external appearance of the micro SD Express card 2000 may be as shown in FIG. 4.

FIG. 4 is a bottom view of the micro SD Express card 2000. Referring to FIG. 4, a plurality of pins for electrical contact with micro SD Express slots may be formed in a bottom surface of the micro SD Express card 2000, and a function of each pin is described below.

The plurality of pins may be formed in the bottom surface of the micro SD Express card 2000 for electrical connection with the slots, and in some embodiments, the total number of pins may be 17 according to FIG. 4. In some embodiments, each pin may have a rectangular shape. Table 1 below may be referred to for signal names corresponding to the pins and brief information about each pin.

TABLE 1

| | signal | |
|---|---|---|
| No. | names | description |
| 1 | PERST# | reset signal |
| 4 | VDD1 | first supply voltage |
| 7 | REFCLK+ | Differential clock signal input from a host to |
| 8 | REFCLK− | the micro SD Express card 2000 (REFCLK+ is |
| | | a positive node, REFCLK− is a negative node) |
| 9 | CLKREQ# | Reference clock request signal |
| 10 | VSS3 | Ground (GND) |
| 11 | PCIe TX+ | Differential output signal output from the micro |
| 12 | PCIe TX− | SD Express card 2000 to the host (PCIe TX+ is |
| | | a positive node, PCIe TX− is a negative node) |
| 13 | VSS4 | Ground (GND) |
| 14 | VDD2 | Second supply voltage |
| 15 | PCIe RX− | Differential input signal input from the host to |
| 16 | PCIe RX+ | the micro SD Express card 2000 (PCIe RX− is |
| | | negative node, PCIe RX+ is positive node) |
| 17 | VSS5 | Ground (GND) |

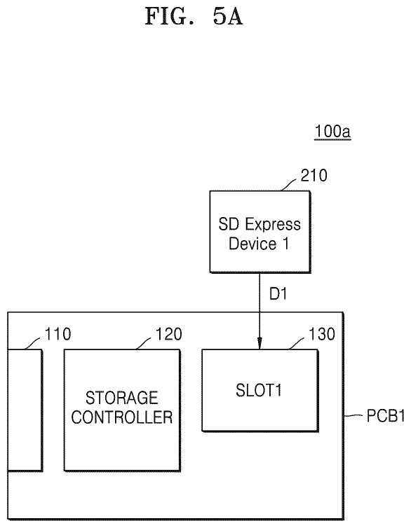

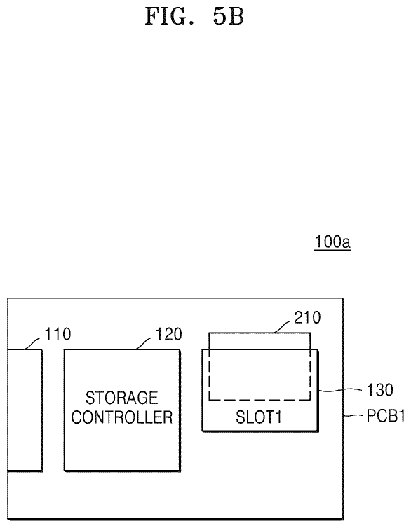

FIGS. 5A and 5B are diagrams illustrating a storage device 100a according to an embodiment. FIG. 5A illustrates the storage device 100a with the SD Express device 210 separated (i.e., not mounted), and FIG. 5B illustrates the storage device 100a with the SD Express device 210 mounted.

For brevity of the drawing, some configurations of the storage device 100a are shown. However, the scope of the present disclosure is not limited thereto, and, in some embodiments, the storage device 100a may further include other components (e.g., a buffer memory, an additional NVM device, an auxiliary power supply, etc.)

Referring to FIGS. 1, 5A and 5B, the storage device 100a may include a printed circuit board PCB1, a controller socket (not shown), the host interface connector 110, the storage controller 120, and the first slot 130. In some embodiments, the storage device 100a may further include the first SD Express device 210. For convenience of description and for conciseness, detailed descriptions of the components described above are omitted.

In an embodiment, the controller socket may be a region, a configuration, or a device in which the storage controller 120 is mounted. The first slot 130 may be a region, a configuration, or a device in which the first SD Express device 210 is mounted. The host interface connector 110, the storage controller 120, and the first SD Express device 210 may be connected to each other by wiring patterns (not shown) provided on (and/or in) the printed circuit board PCB1.

The host interface connector 110 may include a plurality of pins coupled to the external host 10. The number and arrangement of the plurality of pins of the host interface connector 110 may vary depending on a communication interface between the storage device 100a and the external host 10. For example, the storage device 100a may communicate with an external host according to any one of interfaces such as Universal Serial Bus (USB), Peripheral Component Interconnect Express (PCI-Express), Serial Advanced Technology Attachment (SATA), Small Computer System Interface (SCSI), SD Express (Universal Flash Storage), M-Phy, etc. In particular, a SATA standard covers not only SATA-1 but also all SATA series standards such as SATA-2, SATA-3, and external SATA (e-SATA). A PCIe standard covers not only PCIe 1.0, but also all PCIe series standards such as PCIe 2.0, PCIe 2.1, PCIe 3.0, and PCIe 4.0. An SCSI standard covers all SCSI series standards such as Parallel SCSI, Serial Attached SA-SCSI (SAS), and iSCSI. In some embodiments, host interface connector 110 may be a connector configured to support an M.2 interface, an mSATA interface, or a 2.5″ interface.

For example, the storage device 100a may operate by power supplied from the external host 10 through the host interface connector 110. In some embodiments, the storage device 100a may further include a Power Management Integrated Circuit (PMIC) that distributes power supplied from the external host 10 to the storage controller 120 and the first SD Express device 210.

In some embodiments, the storage controller 120 may be permanently mounted or installed on the controller socket such that the storage controller 120 is not separable again after being mounted or installed on the controller socket. In some embodiments, the first SD Express device 210 may be detachably disposed in the first slot 130.

For example, the first SD Express device 210 may be mounted in the first slot 130 in a first direction D1. Alternatively, the first SD Express device 210 may be separated from the first slot 130 in a direction opposite to the first direction D1. In an embodiment, the first SD Express device 210 may be physically and electrically connected to the first SD Express device 210 only by an operation of being inserted into the first slot 130.

As shown in FIG. 4, the micro SD Express card 2000 may include a plurality of pins capable of inputting/outputting power, signals, and/or data. The first slot 130 may include slot pins (or slot terminals) electrically connected to the plurality of pins of the micro SD Express card 2000 when the micro SD Express card 2000 is mounted in the first slot 130.

In an embodiment, the first slot 130 may be provided to receive the insertion of the first SD Express device 210 and to be in contact with the first SD Express device 210. The first slot 130 may be configured to be electrically connected to the first SD Express device 210 when the first SD Express device 210 is mounted in the first slot 130. The first SD Express device 210 may operate by being inserted into the first slot 130 and contacting the slot pins.

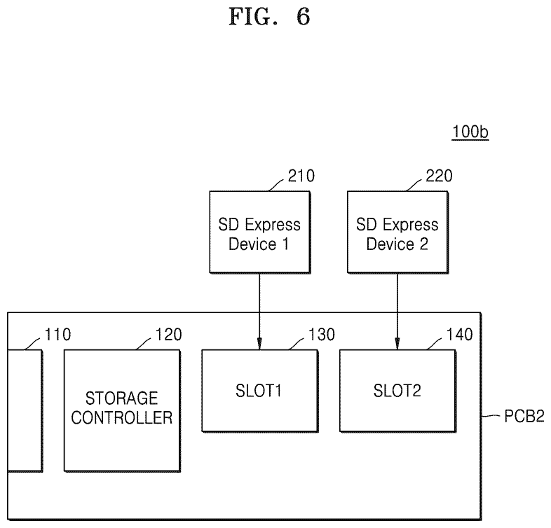

FIG. 6 is a diagram illustrating a storage device 100b according to an embodiment.

Referring to FIG. 6, the storage device 100b may include a printed circuit board PCB2, a controller socket (not shown), the host interface connector 110, the storage controller 120, the first slot 130, and the second slot 140. In some embodiments, the storage device 100b may further include the first SD Express device 210 and the second SD Express device 220. For convenience of description and for conciseness, detailed descriptions of the components described above are omitted.

The storage device 100a of FIGS. 5A and 5B includes one first slot 130, while the storage device 100b of FIG. 6 may include two slots (e.g., the first slot 130 and the second slot 140). Accordingly, the storage device 100b may receive the first and second SD Express devices 210 and 220.

In an embodiment, the storage device 100b includes the first slot 130 and the second slot 140, but only the first SD Express device 210 may be inserted into the first slot 130. In this case, the storage device 100b may store data received from the host 10 only in the first SD Express device 210. The size of a storage space of the storage device 100b may be the same as that of the first SD Express device 210.

Thereafter, the second SD Express device 220 may be additionally inserted into the second slot 140. The storage device 100b may store data received from the host 10 in the first SD Express device 210 and/or the second SD Express device 220 The size of the storage space of the storage device 100b may be the same as the sum of the size of a storage space of the first SD Express device 210 and the size of a storage space of the second SD Express device 220.

In other words, as SD Express devices are additionally inserted into the storage device 100b, the size of the storage space of the storage device 100b may be increased. That is, the size of the storage space of the storage device 100b is not previously determined and may be variable. The size of the storage space of the storage device 100b may be determined according to the number of inserted SD Express devices, the size of the storage space of each of the inserted SD Express devices, etc. In some embodiments, when only the first SD Express device 210 is mounted, the storage device 100b may communicate with the host 10 by using only a first lane. When both the first SD Express device 210 and the second SD Express device 220 are mounted, the storage device 100b may communicate with the host 10 by using both the first lane and a second lane. The performance or speed of the storage device 100b may be determined according to the number of inserted SD Express devices.

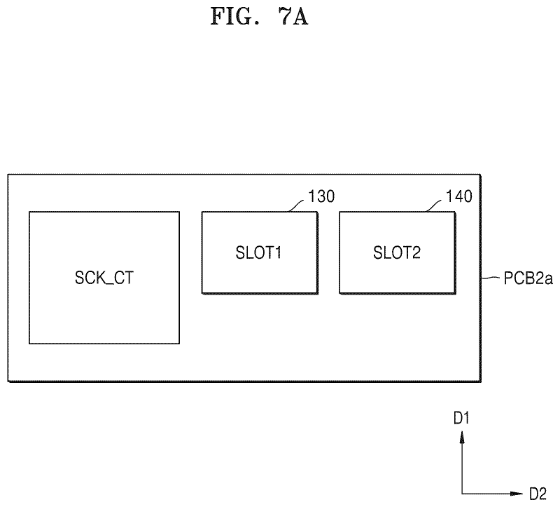

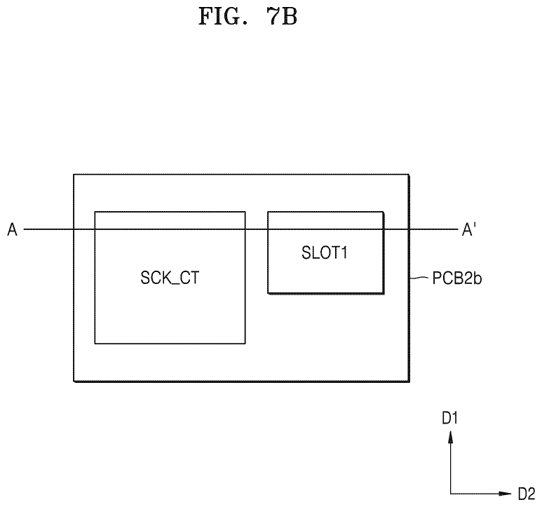

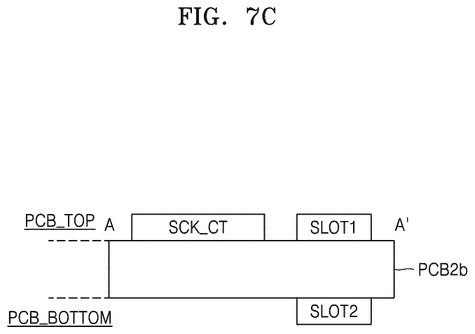

FIGS. 7A to 7C are diagrams illustrating printed circuit boards PCB2a and PCB2b according to an embodiment. FIG. 7A is a plan view illustrating a top surface of the printed circuit board PCB2a according to an embodiment, FIG. 7B is a plan view illustrating a top surface of the printed circuit board PCB2b according to an embodiment, and FIG. 7C is an A-A′ cross-sectional view of the printed circuit board PCB2b of FIG. 7B.

The printed circuit boards PCB2a and PCB2b applicable to the storage device 200 of FIG. 1 are described with reference to FIGS. 7A to 7C. For brevity of the drawing, only the printed circuit boards PCB2a and PCB2b, a controller socket SCK_CT, the first slot 130, and the second slot 140 are shown in FIGS. 7A to 7C.

Referring to FIG. 7A, the printed circuit board PCB2a may include the controller socket SCK_CT, the first slot 130, and the second slot 140. The controller socket SCK_CT of FIG. 7A may be located in a region on one side of the printed circuit board PCB2a. For example, the controller socket SCK_CT may be disposed in a region of one side of a printed circuit board PCB, and the plurality of slots 130 and 140 may be disposed in the remaining region on the one side of the printed circuit board PCB. The controller socket SCK_CT, the first slot 130, and the second slot 140 may be disposed in a second direction D2. The second slot 140 may be disposed on the same surface as the first slot 130.

Referring to FIGS. 7B and 7C, the printed circuit board PCB2b may include the controller socket SCK_CT, the first slot 130, and the second slot 140. The controller socket SCK_CT of FIGS. 7B and 7C may be located in a region on one side of the printed circuit board PCB2b. For example, the controller socket SCK_CT may be disposed in a region on one side of the printed circuit board PCB, and the first slot 130 may be disposed in the remaining region on the one side of the printed circuit board PCB. The controller socket SCK_CT and the first slot 130 may be disposed in the second direction D2.

The first and second slots 130 and 140 may be disposed to face each other with respect to the printed circuit board PCB2b. In other words, the controller socket SCK_CT and the first slot 130 may be disposed on a top surface PCB_TOP of the printed circuit board PCB2b, and the second slot 140 may be disposed on a bottom surface PCB_BOTTOM of the printed circuit board PCB2b.

As described above, the first slot 130 and the second slot 140 of FIG. 7A may be disposed on the same surface of the printed circuit board PCB2a. The first slot 130 and the second slot 140 of FIGS. 7B and 7C may be disposed on different surfaces of the printed circuit board PCB2b.

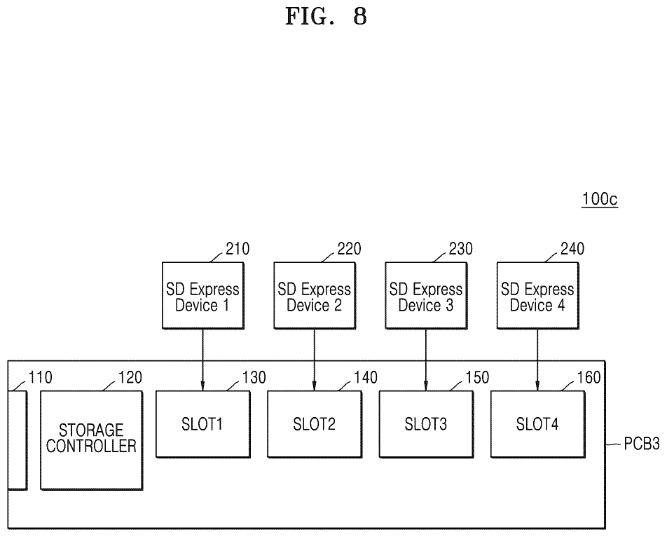

FIG. 8 is a diagram illustrating a storage device 100c according to an embodiment.

Referring to FIG. 8, the storage device 100c may include the host interface connector 110, the storage controller 120, first to fourth slots 130, 140, 150, and 160, and a printed circuit board PCB3. In some embodiments, the storage device 100c may further include a first SD Express device 210, a second SD Express device 220, a third SD Express device 230, and a fourth SD Express device 240. For convenience of description and for conciseness, detailed descriptions of the components described above are omitted.

The storage device 100a of FIGS. 5A and 5B may include one slot 130 and the storage device 100b of FIG. 6 may include the two slots 130 and 140, whereas the storage device 100c of FIG. 8 may include the four slots 130, 140, 150, and 160. Accordingly, the storage device 100c may receive the first to fourth SD Express devices 210, 220, 230, and 240. That is, the first to fourth SD Express devices 210, 220, 230, and 240 may be mounted on corresponding ones of the four slots 130, 140, 150, and 160 on the storage device 100c.

In an embodiment, pins forming a first lane among pins of the host interface connector 110 may be connected to the first slot 130, pins forming a second lane among the pins of the host interface connector 110 may be connected to the second slot 140, pins forming a third lane among the pins of the host interface connector 110 may be connected to the third slot 150, and pins forming a fourth lane among the pins of the host interface connector 110 may be connected to the fourth slot 160.

The host interface connector 110 may include a plurality of first pins. The first slot 130 may include a plurality of second pins. The second slot 140 may include a plurality of fourth pins. The third slot 150 may include a plurality of sixth pins. The fourth slot 160 may include a plurality of eighth pins. The first SD Express device 210 may include a plurality of third pins. The second SD Express device 220 may include a plurality of fifth pins. The third SD Express device 230 may include a plurality of seventh pins. The fourth SD Express device 240 may include a plurality of ninth pins.

Among the plurality of first pins, the first receive pin RX1_P, the second receive pin RX2_P, the first transmit pin TX1_P, and the second transmit pin TX2_P may form the first lane. Among the plurality of first pins, a third receive pin RX3_P, a fourth receive pin RX4_P, a third transmit pin TX3_P, and a fourth transmit pin TX4_P may form the second lane. Among the plurality of first pins, a fifth receive pin RX5_P, a sixth receive pin RX6_P, a fifth transmit pin TX5_P, and a sixth transmit pin TX6_P may form the third lane. Among the plurality of first pins, a seventh receive pin RX7_P, an eighth receive pin RX8_P, a seventh transmit pin TX7_P, and an eighth transmit pin TX8_P may form the fourth lane.

For example, the first receive pin RX1_P may receive the first differential input signal RX+, the second receive pin RX2_P may receive the second differential input signal RX−, the first transmit pin TX1_P may transmit the first differential output signal TX+, and the second transmit pin TX2_P may transmit the second differential output signal TX−. The third receive pin RX3_P may receive the first differential input signal RX+, the fourth receive pin RX4_P may receive the second differential input signal RX−, the third transmit pin TX3_P may transmit the first differential output signal TX+, and the fourth transmit pin TX4_P may transmit the second differential output signal TX−.

The fifth receive pin RX5_P may receive the first differential input signal RX+, the sixth receive pin RX6_P may receive the second differential input signal RX−, the fifth transmit pin TX5_P may transmit the first differential output signal TX+, and the sixth transmit pin TX6_P may transmit the second differential output signal TX−. The seventh receive pin RX7_P may receive the first differential input signal RX+, the eighth receive pin RX8_P may receive the second differential input signal RX−, the seventh transmit pin TX7_P may transmit the first differential output signal TX+, and the eighth transmit pin TX8_P may transmit the second differential output signal TX−.

The first receive pin RX1_P among the plurality of first pins may be connected to the first receive pin RX1_P among the plurality of second pins through a first signal line. The second receive pin RX2_P among the plurality of first pins may be connected to the second receive pin RX2_P among the plurality of second pins through a second signal line. The first transmit pin TX1_P among the plurality of first pins may be connected to the first transmit pin TX1_P among the plurality of second pins through a third signal line. The second transmit pin TX2_P among the plurality of first pins may be connected to the second transmit pin TX2_P among the plurality of second pins through a fourth signal line.

The third receive pin RX3_P among the plurality of first pins may be connected to the first receive pin RX1_P among the plurality of fourth pins through a fifth signal line. The fourth receive pin RX4_P among the plurality of first pins may be connected to the second receive pin RX2_P among the plurality of fourth pins through a sixth signal line. The third transmit pin TX3_P among the plurality of first pins may be connected to the first transmit pin TX1_P among the plurality of fourth pins through a seventh signal line. The fourth transmit pin TX4_P among the plurality of first pins may be connected to the second transmit pin TX2_P among the plurality of fourth pins through an eighth signal line.

The fifth receive pin RX5_P among the plurality of first pins may be connected to the first receive pin RX1_P among the plurality of sixth pins through a ninth signal line. The sixth receive pin RX6_P among the plurality of first pins may be connected to the second receive pin RX2_P among the plurality of sixth pins through a tenth signal line. The fifth transmit pin TX5_P among the plurality of first pins may be connected to the first transmit pin TX1_P among the plurality of sixth pins through an eleventh signal line. The sixth transmit pin TX6_P among the plurality of first pins may be connected to the second transmit pin TX2_P among the plurality of sixth pins through a twelfth signal line.

The seventh receive pin RX7_P among the plurality of first pins may be connected to the first receive pin RX1_P among the plurality of eighth pins through a thirteenth signal line. The eighth receive pin RX8_P among the plurality of first pins may be connected to the second receive pin RX2_P among the plurality of eighth pins through a fourteenth signal line. The seventh transmit pin TX7_P among the plurality of first pins may be connected to the first transmit pin TX1_P among the plurality of eighth pins through a fifteenth signal line. The eighth transmit pin TX8_P among the plurality of first pins may be connected to the second transmit pin TX2_P among the plurality of eighth pins through a sixteenth signal line.

The first receive pin RX1_P among the plurality of second pins may be coupled to the first receive pin RX1_P among the plurality of third pins. The second receive pin RX2_P among the plurality of second pins may be coupled to the second receive pin RX2_P among the plurality of third pins. The first transmit pin TX1_P among the plurality of second pins may be coupled to the first transmit pin TX1_P among the plurality of third pins. The second transmit pin TX2_P among the plurality of second pins may be coupled to the second transmit pin TX2_P among the plurality of third pins.

The first receive pin RX1_P among the plurality of fourth pins may be coupled to the first receive pin RX1_P among the plurality of fifth pins. The second receive pin RX2_P among the plurality of fourth pins may be coupled to the second receive pin RX2_P among the plurality of fifth pins. The first transmit pin TX1_P among the plurality of fourth pins may be coupled to the first transmit pin TX1_P among the plurality of fifth pins. The second transmit pin TX2_P among the plurality of fourth pins may be coupled to the second transmit pin TX2_P among the plurality of fifth pins.

The first receive pin RX1_P among the plurality of sixth pins may be coupled to the first receive pin RX1_P among the plurality of seventh pins. The second receive pin RX2_P among the plurality of sixth pins may be coupled to the second receive pin RX2_P among the plurality of seventh pins. The first transmit pin TX1_P among the plurality of sixth pins may be coupled to the first transmit pin TX1_P among the plurality of seventh pins. The second transmit pin TX2_P among the plurality of sixth pins may be coupled to the second transmit pin TX2_P among the plurality of seventh pins.

The first receive pin RX1_P among the plurality of eighth pins may be coupled to the first receive pin RX1_P among the plurality of ninth pins. The second receive pin RX2_P among the plurality of eighth pins may be coupled to the second receive pin RX2_P among the plurality of ninth pins. The first transmit pin TX1_P among the plurality of eighth pins may be coupled to the first transmit pin TX1_P among the plurality of ninth pins. The second transmit pin TX2_P among the plurality of eighth pins may be coupled to the second transmit pin TX2_P among the plurality of ninth pins.

As described above, when only the first SD Express device 210 is mounted, the storage device 100c may communicate with the host 10 by using only the first lane, and the size of a storage space of the storage device 100c may be the same as the size of the first SD Express device 210. When all of the first to fourth SD Express devices 210, 220, 230, and 240 are mounted, the storage device 100c may communicate with the host 10 by using the first to fourth lanes, and the size of the storage space of the storage device 100c may be the same as the sum of the sizes of storage spaces of the first to fourth SD Express devices 210, 220, 230, and 240. When four SD Express devices are mounted, a high-capacity/high-performance storage device may be provided.

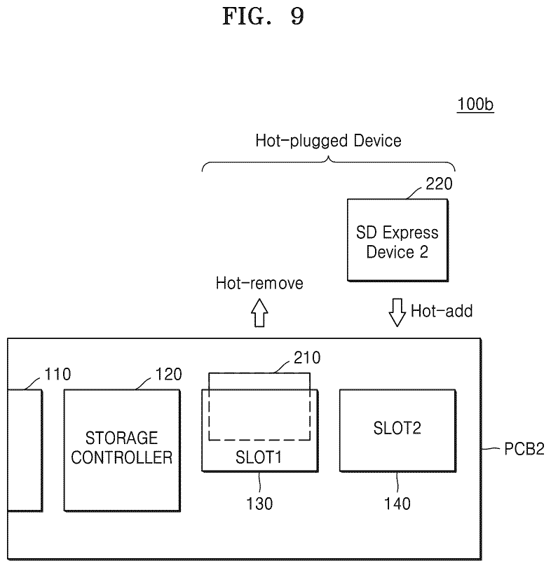

FIG. 9 is a diagram illustrating a storage device 100b according to an embodiment.

Hereinafter, for convenience of description and for conciseness, detailed descriptions of redundant components are omitted. Referring to FIG. 9, the storage device 100b may include the host interface connector 110, the storage controller 120, the first slot 130, the second slot 140, the printed circuit board PCB2, and the first SD Express device 210. The first SD Express device 210 may be inserted into and mounted in the first slot 130.

In an embodiment, while the storage device 100b is being driven, some (e.g., the first SD Express device 210) of SD Express devices may be disconnected or hot-removed from a slot. In some embodiments, while the storage device 100b is being driven, some (e.g., the SD Express device 220) of SD Express devices may be connected to or hot-added to the slot (e.g., the second slot 140). In this case, the storage controller 120 or the host 10 may perform an initialization operation on devices connected to the slot again through a reset operation or a hot-plug operation. That is, an SD Express device according to an embodiment may support a hot-plug function, and may expand the storage capacity of the storage device 100b through various connections.

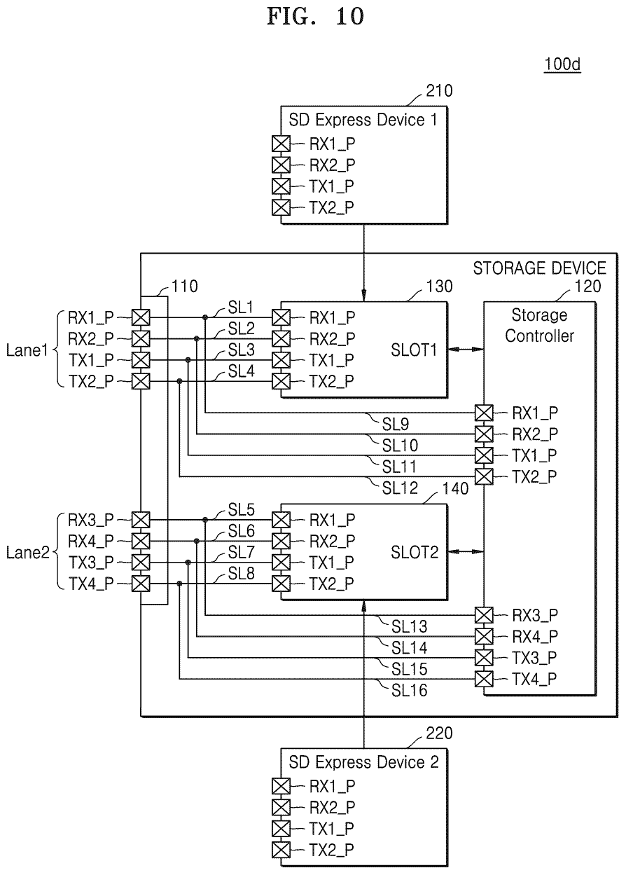

FIG. 10 is a block diagram illustrating a storage device 100d according to an embodiment.

Referring to FIGS. 1 and 10, the storage device 100d may include the host interface connector 110, the storage controller 120, the first slot 130, and the second slot 140. The storage device 100d may further include first to sixteenth signal lines SL1 to SL16. In some embodiments, the storage device 100d may further include the first SD Express device 210 and the second SD Express device 220.

The host interface connector 110 may include a plurality of first pins. The first slot 130 may include a plurality of second pins. The first SD Express device 210 may include a plurality of third pins. The second slot 140 may include a plurality of fourth pins. The second SD Express device 220 may include a plurality of fifth pins. The storage controller 120 may include a plurality of tenth pins.

The plurality of first pins may include the first receive pin RX1_P, the second receive pin RX2_P, the third receive pin RX3_P, the fourth receive pin RX4_P, the first transmit pin TX1_P, the second transmit pin TX2_P, the third transmit pin TX3_P, and the fourth transmit pin TX4_P. The plurality of second pins may include the first receive pin RX1_P, the second receive pin RX2_P, the first transmit pin TX1_P, and the second transmit pin TX2_P. The plurality of third pins may include the first receive pin RX1_P, the second receive pin RX2_P, the first transmit pin TX1_P, and the second transmit pin TX2_P. The plurality of fourth pins may include the first receive pin RX1_P, the second receive pin RX2_P, the first transmit pin TX1_P, and the second transmit pin TX2_P. The plurality of fifth pins may include the first receive pin RX1_P, the second receive pin RX2_P, the first transmit pin TX1_P, and the second transmit pin TX2_P. The plurality of tenth pins may include the first receive pin RX1_P, the second receive pin RX2_P, the third receive pin RX3_P, the fourth receive pin RX4_P, the first transmit pin TX1_P, the second transmit pin. TX2_P, the third transmit pin TX3_P, and the fourth transmit pin TX4_P.

Connection relationships between the plurality of first pins and the plurality of second pins are the same as those described with reference to FIG. 2, and thus, descriptions thereof are omitted for conciseness. Connection relationships between the plurality of first pins and the plurality of fourth pins are the same as those described with reference to FIG. 2, and thus, descriptions thereof are omitted for conciseness. Connection relationships between the plurality of second pins and the plurality of third pins are the same as those described with reference to FIG. 2, and thus, descriptions thereof are omitted for conciseness. Connection relationships between the plurality of fourth pins and the plurality of fifth pins are the same as those described with reference to FIG. 2, and thus, descriptions thereof are omitted for conciseness.

The first receive pin RX1_P among the plurality of tenth pins may be connected to the first receive pin RX1_P among the plurality of first pins. The second receive pin RX2_P among the plurality of tenth pins may be connected to the second receive pin RX2_P among the plurality of first pins. The first transmit pin TX1_P among the plurality of tenth pins may be connected to the first transmit pin TX1_P among the plurality of first pins. The second transmit pin TX2_P among the plurality of tenth pins may be connected to the second transmit pin TX2_P among the plurality of first pins.

The third receive pin RX3_P among the plurality of tenth pins may be connected to the third receive pin RX3_P among the plurality of first pins. The fourth receive pin RX4_P among the plurality of tenth pins may be connected to the fourth receive pin RX4_P among the plurality of first pins. The third transmit pin TX3_P among the plurality of tenth pins may be connected to the third transmit pin TX3_P among the plurality of first pins. The fourth transmit pin TX4_P among the plurality of tenth pins may be connected to the fourth transmit pin TX4_P among the plurality of first pins.

In an embodiment, the storage device 100d may further include the ninth to sixteenth signal lines SL9 to SL16 compared to FIG. 2. The ninth signal line SL9 may connect the first receive pin RX1_P among the plurality of first pins to the first receive pin RX1_P among the plurality of tenth pins. The tenth signal line SL10 may connect the second receive pin RX2_P among the plurality of first pins to the second receive pin RX2_P among the plurality of tenth pins. The eleventh signal line SL11 may connect the first transmit pin TX1_P among the plurality of first pins to the first transmit pin TX1_P among the plurality of tenth pins. The twelfth signal line SL12 may connect the second transmit pin TX2_P among the plurality of first pins to the second transmit pin TX2_P among the plurality of tenth pins.

The thirteenth signal line SL13 may connect the third receive pin RX3_P among the plurality of first pins to the third receive pin RX3_P among the plurality of tenth pins. The fourteenth signal line SL14 may connect the fourth receive pin RX4_P among the plurality of first pins to the fourth receive pin RX4_P among the plurality of tenth pins. The fifteenth signal line SL15 may connect the third transmit pin TX3_P among the plurality of first pins to the third transmit pin TX3_P among the plurality of tenth pins. The sixteenth signal line SL16 may connect the fourth transmit pin TX4_P among the plurality of first pins to the fourth transmit pin TX4_P among the plurality of tenth pins.

Accordingly, among the plurality of first pins, the first and second receive and transmit pins RX1_P, RX2_P, TX1_P, and TX2_P forming a first lane may be connected to both the first slot 130 and the storage controller 120. Among the plurality of first pins, the third and fourth receive and transmit pins RX3_P, RX4_P, TX3_P, and TX4_P forming a second lane may be connected to both the second slot 140 and the storage controller 120. The host 10 may communicate with the first SD Express device 210 or the storage controller 120 through the first lane. The host 10 may communicate with the second SD Express device 220 or the storage controller 120 through the second lane.

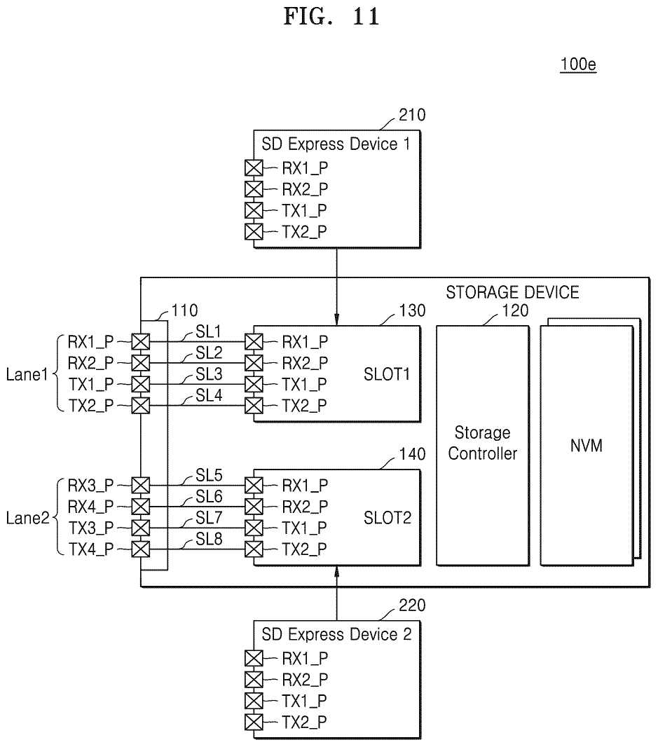

FIG. 11 is a block diagram illustrating a storage device 100e according to an embodiment.

Referring to FIG. 11, the storage device 100e may include the host interface connector 110, the storage controller 120, the first slot 130, the second slot 140, and a plurality of NVM devices. In some embodiments, the storage device 100e may further include the first SD Express device 210 and the second SD Express device 220. For brevity of the drawing and convenience of description and for conciseness, detailed descriptions of components which are the same as or similar to those described with reference to FIG. 2 are omitted.

In an embodiment, compared to FIG. 2, the storage device 100e may further include a plurality of built-in (or embedded) NVM devices. The plurality of NVM devices may be configured to be built-in to the storage device 100e and to be not detachable from the storage device 100e. The plurality of NVM devices may transmit and receive data under the control of the storage controller 120. Each of the plurality of NVM devices may include a flash memory. The flash memory may include a 2D NAND memory array or a 3D (or VNAND) memory array. In an embodiment, the storage device 100e may include other various types of non-volatile memories. For example, MRAM, spin-transfer torque MRAM, CBRAM, FeRAM, PRAM, resistive memory, and other various types of memories may be applied to the storage device 100e.

In an embodiment, the storage controller 120 may further include a NVM interface circuit (not shown). The NVM interface circuit may transmit data to be written to the plurality of NVM devices to the plurality of NVM devices or receive data read from the plurality of NVM devices. Such a NVM interface circuit may be implemented to comply with a standard such as Toggle or ONFI.

The plurality of NVM devices may receive and store data provided from the host 10 through the storage controller 120. The plurality of NVM devices may transmit data read from the plurality of NVM devices to the host 10 through the storage controller 120. In some embodiments, the first and second SD Express devices 210 and 220 may directly receive and store data provided from the host 10. The first and second SD Express devices 210 and 220 may directly transmit read data to the host 10. That is, the first and second SD Express devices 210 and 220 may directly communicate with the host 10 without the storage controller 120.

As described above, in some embodiments, the storage device 100 of FIG. 2 may include only the detachable SD Express devices 210 and 220. In some embodiments, the storage device 100e of FIG. 11 may include both the detachable SD Express devices 210 and 220 and the plurality of built-in NVM devices. The plurality of built-in NVM devices may communicate with the storage controller 120 through the NVM interface circuit.

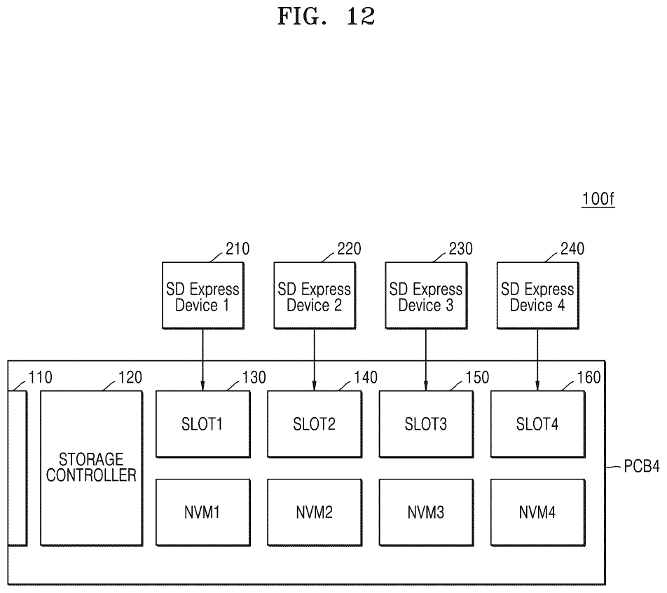

FIG. 12 is a block diagram illustrating a storage device 100f according to an embodiment.

Referring to FIG. 12, the storage device 100f may include the host interface connector 110, the storage controller 120, the first slot 130, the second slot 140, the third slot 150, the fourth slot 160, a printed circuit board PCB4, and a plurality of NVM devices NVM1 to NVM4. In some embodiments, the storage device 100f may further include the first SD Express device 210, the second SD Express device 220, a third SD Express device 230, and a fourth SD Express device 240. For brevity of the drawing and convenience of description and for conciseness, detailed descriptions of components which are the same as or similar to those described with reference to FIG. 8 are omitted.

The printed circuit board PCB4 may include a controller socket (not shown), the first to fourth slots 130, 140, 150, and 160, and first to fourth memory sockets (not shown). A memory socket may be a region, a configuration, or a device in which an NVM is mounted. For example, the first memory socket may be a region, a configuration, or a device in which the first NVM NVM1 is mounted, the second memory socket may be a region, a configuration, or a device in which the second NVM NVM2 is mounted, the third memory socket may be a region, a configuration, or a device in which the third NVM NVM3 is mounted, and the fourth memory socket may be a region, a configuration, or a device in which the fourth NVM NVM4 is mounted.

Unlike the first to fourth SD Express devices 210, 220, 230, and 240, the first to fourth NVM devices NVM1, NVM2, NVM3, and NVM4 may be permanently mounted on the printed circuit board PCB4 and may be non-detachable. That is, the first to fourth NVM devices NVM1, NVM2, NVM3, and NVM4 may not be separated again after being mounted or installed in memory sockets corresponding thereto during manufacturing (or mass production).

Accordingly, the size of a minimum storage space of the storage device 100f may be determined according to the first to fourth NVM devices NVM1, NVM2, NVM3, and NVM4. For example, when all of the first to fourth SD Express devices 210, 220, 230, and 240 are not inserted, the storage device 100f may store data received from the host 10 only in the first to fourth NVM devices NVM1, NVM2, NVM3, and NVM4. The size of the storage space of the storage device 100f may be determined according to storage spaces of the first to fourth NVM devices NVM1, NVM2, NVM3, and NVM4.

Thereafter, the first SD Express device 210 may be inserted into the storage device 100f. The storage device 100f may store data received from the host 10 in the first SD Express device 210 as well as in the first to fourth NVM devices NVM1, NVM2, NVM3, and NVM4. As the first SD Express device 210 is inserted, the size of the storage space of the storage device 100f may be increased. Similarly, as additional ones of the second to fourth SD Express devices 220, 230, and 240 are inserted into the storage device 100f, the size of the storage space of the storage device 100f may be further increased.

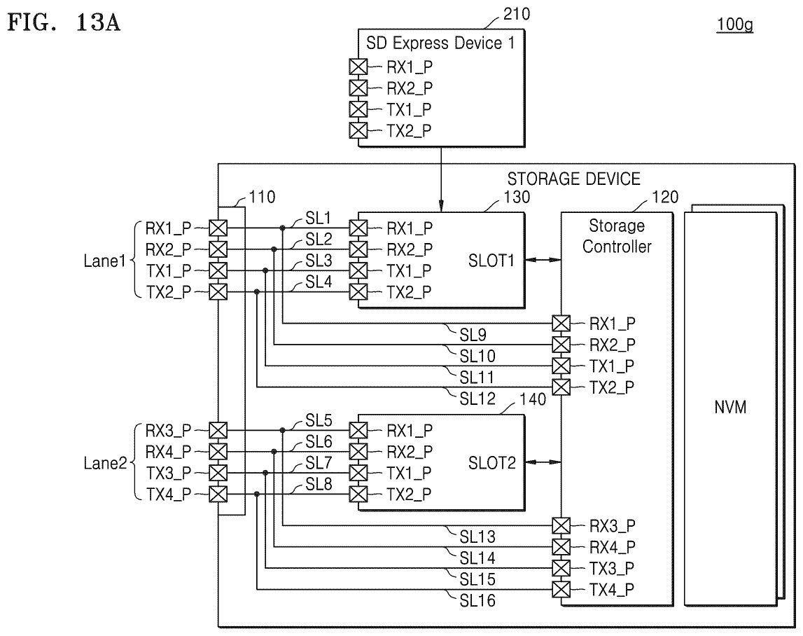

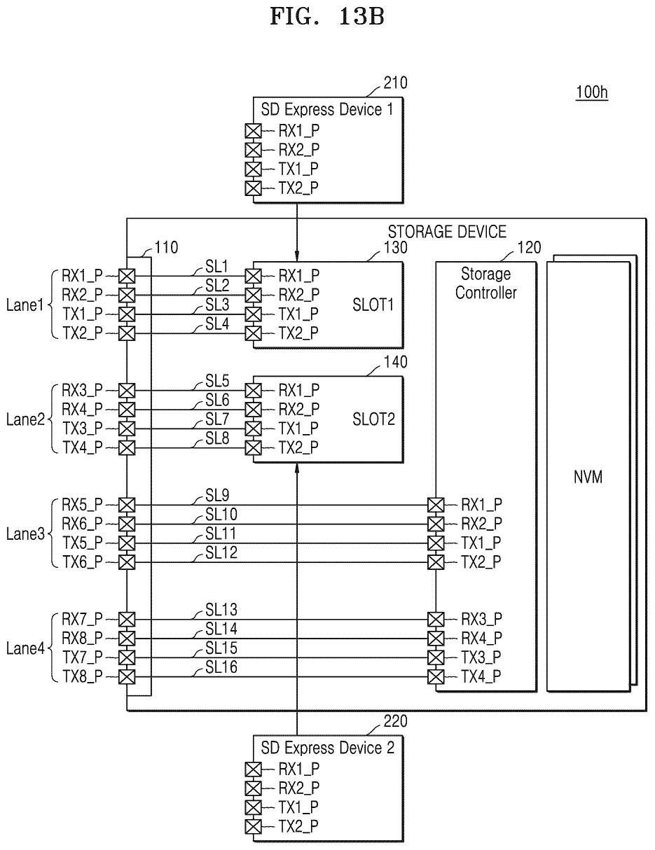

FIGS. 13A and 13B are block diagrams illustrating storage devices 100g and 100h according to an embodiment.

Referring to FIG. 13A, the storage device 100g may include the host interface connector 110, the storage controller 120, the first slot 130, the second slot 140, the first to sixteenth signal lines SL1 to SL16, and a plurality of NVM devices. In some embodiments, the storage device 100g may further include the first SD Express device 210. For brevity of the drawing and convenience of explanation and for conciseness, detailed descriptions of components which are the same as or similar to those described with reference to FIGS. 10 and 11 are omitted.

In FIG. 13A, it is assumed that the first SD Express device 210 is mounted in the first slot 130, and the second SD Express device 220 is removed from the second slot 140. That is, the storage device 100g may include only the first SD Express device 210 among a plurality of SD Express devices.

Among a plurality of first pins, the first and second receive and transmit pins RX1_P, RX2_P, TX1_P, and TX2_P forming a first lane may be connected to the first slot 130. Also, among the plurality of first pins, the first and second receive and transmit pins RX1_P, RX2_P, TX1_P, and TX2_P forming the first lane may be connected to the storage controller 120. Among the plurality of first pins, the third and fourth receive and transmit pins RX3_P, RX4_P, TX3_P, and TX4_P forming a second lane may be connected to the second slot 140. Among the plurality of first pins, the third and fourth receive and transmit pins RX3_P, RX4_P, TX3_P, and TX4_P forming the second lane may be connected to the storage controller 120.

Some of the plurality of first pins may be connected to the first slot 130 through the first to fourth signal lines SL1 to SL4. The remaining pins of the plurality of first pins may be connected to the second slot 140 through the fifth to eighth signal lines SL5 to SL8. The plurality of first pins may be connected to the storage controller 120 through the ninth to sixteenth signal lines SL9 to SL16. This description is the same as or similar to that given with reference to FIG. 10, and thus, detailed descriptions thereof are omitted for conciseness.

The first SD Express device 210 is mounted in the first slot 130, and thus, the first and second receive and transmit pins RX1_P, RX2_P, TX1_P, and TX2_P forming the first lane among the plurality of first pins may be used for communication between the host 10 and the first SD Express device 210. For example, the host 10 may transmit a write request and write data to the first SD Express device 210 through the first and second receive and transmit pins RX1_P, RX2_P, TX1_P, and TX2_P forming the first lane among the plurality of first pins. The host 10 may transmit a read request to the first SD Express device 210 through the first and second receive and transmit pins RX1_P, RX2_P, TX1_P, and TX2_P forming the first lane among the first pins, and receive read data from the first SD Express device 210.

In other words, the host 10 may store the write data in the first SD Express device 210 through the first and second receive and transmit pins RX1_P, RX2_P, TX1_P, and TX2_P forming the first lane among the plurality of first pins. The host 10 may read data stored in the first SD Express device 210 through the first and second receive and transmit pins RX1_P RX2_P, TX1_P, and TX2_P forming the first lane among the plurality of first pins.

The second SD Express device 220 is removed from the second slot 140, and thus, the third and fourth receive and transmit pins RX3_P, RX4_P, TX3_P, and TX4_P forming the second lane among the plurality of first pins may be used for communication between the host 10 and the storage controller 120. The host 10 may transmit a write request and write data to the storage controller 120 through the third and fourth receive and transmit pins RX3_P, RX4_P, TX3_P, and TX4_P forming the second lane among the plurality of first pins. The host 10 may transmit a read request to the storage controller 120 through the third and fourth receive and transmit pins RX3_P, RX4_P, TX3_P, and TX4_P forming the second lane among the plurality of first pins, and receive read data from the storage controller 120.

In other words, the host 10 may store the write data in the plurality of NVM devices through the third and fourth receive and transmit pins RX3_P, RX4_P, TX3_P, and TX4_P forming the second lane among the plurality of first pins. The host 10 may read data stored in the plurality of NVM devices through the third and fourth receive and transmit pins RX3_P, RX4_P, TX3_P, and TX4_P forming the second lane among the plurality of first pins.

Referring to FIG. 13B, the storage device 100h may include the host interface connector 110, the storage controller 120, the first slot 130, the second slot 140, the first to sixteenth signal lines SL1 to SL16, and the plurality of NVM devices. In some embodiments, the storage device 100h may further include the first SD Express device 210 and the second SD Express device 220. For brevity of the drawing and convenience of description and for conciseness, detailed descriptions of components which are the same as or similar to those previously described are omitted. In FIG. 13B, it is assumed that the first SD Express device 210 is mounted in the first slot 130, and the second SD Express device 220 is mounted in the second slot 140.

The host interface connector 110 may include a plurality of first pins. The first slot 130 may include a plurality of second pins. The first SD Express device 210 may include a plurality of third pins. The second slot 140 may include a plurality of fourth pins. The second SD Express device 220 may include a plurality of fifth pins. The storage controller 120 may include a plurality of tenth pins.

Among the plurality of first pins, the first and second receive and transmit pins RX1_P, RX2_P, TX1_P, and TX2_P forming a first lane may be connected to the first slot 130. Among the plurality of first pins, the third and fourth receive and transmit pins RX3_P, RX4_P, TX3_P, and TX4_P forming a second lane may be connected to the second slot 140. Among the plurality of first pins, the fifth and sixth receive and transmit pins RX5_P, RX6_P, TX5_P, and TX6_P forming a third lane may be connected to the storage controller 120. Among the plurality of first pins, the seventh and eighth receive and transmit pins RX7_P, RX8_P, TX7_P, and TX8_P forming a fourth lane may be connected to the storage controller 120.

Among the plurality of first pins, the first and second receive and transmit pins RX1_P, RX2_P, TX1_P, and TX2_P forming the first lane may be connected to the first slot 130 through the first to fourth signal lines SL1 to SL4. Among the plurality of first pins, the third and fourth receive and transmit pins RX3_P, RX4_P, TX3_P, and TX4_P forming the second lane may be connected to the second slot 140 through the fifth to eighth signal lines SL5 to SL8. Among the plurality of first pins, the fifth and sixth receive and transmit pins RX5_P, RX6_P, TX5_P, and TX6_P forming the third lane may be connected to the storage controller 120 through the ninth to twelfth signal lines SL9 to SL12. Among the plurality of first pins, the seventh and eighth receive and transmit pins RX7_P, RX8_P, TX7_P, and TX8_P forming the fourth lane may be connected to the storage controller 120 through thirteenth to sixteenth signal lines SL13 to SL16.

Connection relationships between the plurality of first pins and the plurality of second pins are the same as those described with reference to FIG. 10, and thus, descriptions thereof are omitted for conciseness. Connection relationships between the plurality of first pins and the plurality of fourth pins are the same as those described with reference to FIG. 10, and thus, descriptions thereof are omitted for conciseness.

The first receive pin RX1_P among the plurality of tenth pins may be connected to the fifth receive pin RX5_P among the plurality of first pins. The second receive pin RX2_P among the plurality of tenth pins may be connected to the sixth receive pin RX6_P among the plurality of first pins. The first transmit pin TX1_P among the plurality of tenth pins may be connected to the fifth transmit pin TX5_P among the plurality of first pins. The second transmit pin TX2_P among the plurality of tenth pins may be connected to the sixth transmit pin TX6_P among the plurality of first pins.

The third receive pin RX3_P among the plurality of tenth pins may be connected to the seventh receive pin RX7_P among the plurality of first pins. The fourth receive pin RX4_P among the plurality of tenth pins may be connected to the eighth receive pin RX8_P among the plurality of first pins. The third transmit pin TX3_P among the plurality of tenth pins may be connected to the seventh transmit pin TX7_P among the plurality of first pins. The fourth transmit pin TX4_P among the plurality of tenth pins may be connected to the eighth transmit pin TX8_P among the plurality of first pins.

The ninth signal line SL9 may connect the fifth receive pin RX5_P among the plurality of first pins to the first receive pin RX1_P among the plurality of tenth pins. The tenth signal line SL10 may connect the sixth receive pin RX6_P among the plurality of first pins to the second receive pin RX2_P among the plurality of tenth pins. The eleventh signal line SLi1 may connect the fifth transmit pin TX5_P among the plurality of first pins to the first transmit pin TX1_P among the plurality of tenth pins. The twelfth signal line SL12 may connect the sixth transmit pin TX6_P among the plurality of first pins to the second transmit pin TX2_P among the plurality of tenth pins.

The thirteenth signal line SL13 may connect the seventh receive pin RX7_P among the plurality of first pins to the third receive pin RX3_P among the plurality of ten pins. The fourteenth signal line SL14 may connect the eighth receive pin RX8_P among the plurality of first pins to the fourth receive pin RX4_P among the plurality of tenth pins. The fifteenth signal line SL15 may connect the seventh transmit pin TX7_P among the plurality of first pins to the third transmit pin TX3_P among the plurality of tenth pins. The sixteenth signal line SL16 may connect the eighth transmit pin TX8_P among the plurality of first pins to the fourth transmit pin TX4_P among the plurality of tenth pins.

The host 10 may communicate with the first SD Express device 210 through the first and second receive and transmit pins RX1_P, RX2_P, TX1_P, and TX2_P forming the first lane among the plurality of first pins. The host 10 may communicate with the second SD Express device 220 through the third and fourth receive and transmit pins RX3_P, RX4_P, TX3_P, and TX4_P forming the second lane among the plurality of first pins. The host 10 may communicate with the storage controller 120 through the fifth and sixth receive and transmit pins RX5_P, RX6_P, TX5_P, and TX6_P forming the third lane among the plurality of first pins. The host 10 may communicate with the storage controller 120 through the seventh and eighth receive and transmit pins RX7_P, RX8_P, TX7_P, and TX8_P forming the fourth lane among the plurality of first pins.

The host 10 may store write data in the plurality of NVM devices through the fifth and sixth receive and transmit pins RX5_P, RX6_P, TX5_P, and TX6_P forming the third lane among the plurality of first pins. The host 10 may read data stored in the plurality of NVM devices through the fifth and sixth receive and transmit pins RX5_P, RX6_P, TX5_P, and TX6_P forming the third lane among the plurality of first pins.

The host 10 may store write data in the plurality of NVM devices through the seventh and eighth receive and transmit pins RX7_P, RX8_P, TX7_P, and TX8_P forming the fourth lane among the plurality of first pins. The host 10 may read data stored in the plurality of NVM devices through the seventh and eighth receive and transmit pins RX7_P, RX8_P, TX7_P, and TX8_P forming the fourth lane among the plurality of first pins.

As described above, some of a plurality of lanes may be used for communication between an SD Express device and a host. The remaining lanes may be used for communication between a storage controller and the host.

In FIG. 13A, among the plurality of first pins, the first and second receive and transmit pins RX1_P, RX2_P, TX1_P, and TX2_P forming the first lane may be connected to both the first slot 130 and the storage controller 120. Among the plurality of first pins, the third and fourth receive and transmit pins RX3_P, RX4_P, TX3_P, and TX4_P forming the second lane may be connected to both the second slot 140 and the storage controller 120. The first SD Express device 210 may be mounted in the first slot 130, and the first and second receive and transmit pins RX1_P, RX2_P, TX1_P, and TX2_P forming the first lane among the plurality of first pins may be used for communication between the first SD Express device 210 and the host 10. The second SD Express device 220 may be removed from the second slot 140, and the third and fourth receive and transmit pins RX3_P, RX4_P, TX3_P, and TX4_P forming the second lane among the plurality of first pins may be used for communication between the storage controller 120 and the host 10.

In FIG. 13B, among the plurality of first pins, the first and second receive and transmit pins RX1_P, RX2_P, TX1_P, and TX2_P forming the first lane may be connected only to the first slot 130. Among the plurality of first pins, the third and fourth receive and transmit pins RX3_P, RX4_P, TX3_P, and TX4_P forming the second lane may be connected only to the second slot 140. That is, the first and second receive and transmit pins RX1_P, RX2_P, TX1_P, and TX2_P forming the first lane among the plurality of first pins may not be connected to the storage controller 120. Among the plurality of first pins, the third and fourth receive and transmit pins RX3_P, RX4_P, TX3_P, and TX4_P forming the second lane may not be connected to the storage controller 120.

Among the plurality of first pins, the fifth and sixth receive and transmit pins RX5_P, RX6_P, TX5_P, and TX6_P forming the third lane may be connected to the storage controller 120. Among the plurality of first pins, the seventh and eighth receive and transmit pins RX7_P, RX8_P, TX7_P, and TX8_P forming the fourth lane may be connected to the storage controller 120. That is, among the plurality of first pins, the fifth and sixth receive and transmit pins RX5_P, RX6_P, TX5_P, and TX6_P forming the third lane may not be connected to any slot. Among the plurality of first pins, the seventh and eighth receive and transmit pins RX7_P, RX8_P, TX7_P, and TX8_P forming the fourth lane may not be connected to any slot.

Accordingly, the first and second receive and transmit pins RX1_P, RX2_P, TX1_P, and TX2_P forming the first lane among the plurality of first pins may be used for communication between the first SD Express device 210 and the host 10. Among the plurality of first pins, the third and fourth receive and transmit pins RX3_P, RX4_P, TX3_P, and TX4_P forming the second lane may be used for communication between the second SD Express device 220 and the host 10. Among the plurality of first pins, the fifth and sixth receive and transmit pins RX5_P, RX6_P, TX5_P, and TX6_P forming the third lane may be used for communication between the storage controller 120 and the host 10. Among the plurality of first pins, the seventh and eighth receive and transmit pins RX7_P, RX8_P, TX7_P, and TX8_P forming the fourth lane may be used for communication between the storage controller 120 and the host 10.

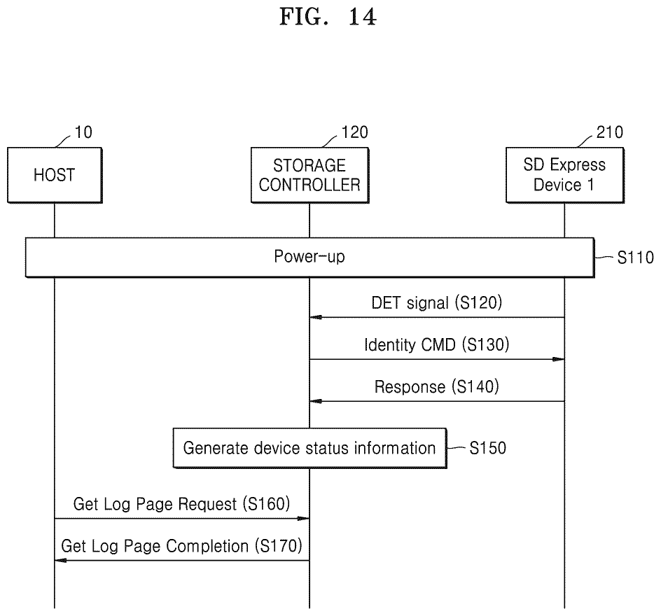

FIG. 14 is a flowchart illustrating an operating method of the storage system 1000 according to an embodiment. It is assumed that the first SD Express device 210 is mounted in the first slot 130.

Referring to FIGS. 1, 3, and 14, in operation S110, the storage system 1000 may be powered up. When the storage system 1000 is powered-up, the host 10 may transmit information about power-up or initialization start to the storage controller 120 (i.e., the storage device 100). In response to the information about power-up or initialization start, the storage device 100 may perform an initialization operation. For example, when the storage controller 120 includes a plurality of NVM devices, the storage controller 120 may check storage capacities of the plurality of NVM devices. The first SD Express device 210 may check the storage capacity of the NVM 212 of the first SD Express device 210.

In operation S120, the storage controller 120 may receive a detection (DET) signal. The first SD Express device 210 may transmit the detection (DET) signal to the storage controller 120. The storage controller 120 may recognize whether the first SD Express device 210 is mounted in or removed from the first slot 130 through the detection (DET) signal.

In operation S130, the storage controller 120 may transmit an identification command (Identity CMD) to the first SD Express device 210. The storage controller 120 may transmit the identification command to the first SD Express device 210 in response to the detection signal. The storage controller 120 may recognize information of the first SD Express device 210 through operations S130 and S140. The storage controller 120 may issue the identification command to the first SD Express device 210 to recognize device information of the first SD Express device 210.

In operation S140, the first SD Express device 210 may output a response to the storage controller 120. The first SD Express device 210 may transmit a response including information about a device type and storage capacity to the storage controller 120 in response to the identification command.

In operation S150, the storage controller 120 may generate device status information. The storage controller 120 may generate the device status information based on the response received from the first SD Express device 210. The device status information may include information about the total number of slots and the number of SD Express devices currently installed, information about mapping relationships between slots and SD Express devices, information about mapping relationships between lanes and SD Express devices, and/or information about a device type, storage capacity, etc. of each of the SD Express devices.

For example, referring to FIG. 2, because the first SD Express device 210 is mounted in the first slot 130, and the second SD Express device 220 is mounted in the second slot 140, the information about mapping relationships between slots and SD Express devices may include data indicating an identifier of the first SD Express device 210 and the first slot 130, and data indicating an identifier of the second SD Express device 220 and the second slot 140.

The first SD Express device 210 may communicate with the host 10 through the first and second receive and transmit pins RX1_P, RX2_P, TX1_P, and TX2_P forming a first lane among first pins, and the second SD Express device 220 may communicate with the host 10 through the third and fourth receive and transmit pins RX3_P, RX4_P, TX3_P, and TX4_P forming a second lane among the first pins, and thus, the information about the mapping relationships between the lanes and the SD Express devices may include data indicating the identifier of the first SD Express device 210 and the first lane, and data indicating the identifier of the second SD Express device 220 and the second lane.

In operation S160, the host 10 may transmit a Get Log Page request to the storage controller 120. The Get Log Page request may include a log identifier, a log data size, and a host memory address where log data read from the storage device 100 is to be stored.

In operation S170, the storage controller 120 may transmit a Get Log Page completion to the host 10. The storage controller 120 may write a log page including the device status information to a host memory address included in a Get Log Page command. Thereafter, the storage controller 120 may transmit the Get Log Page completion. That is, the storage controller 120 may transmit the device status information and the Get Log Page completion to the host 10.

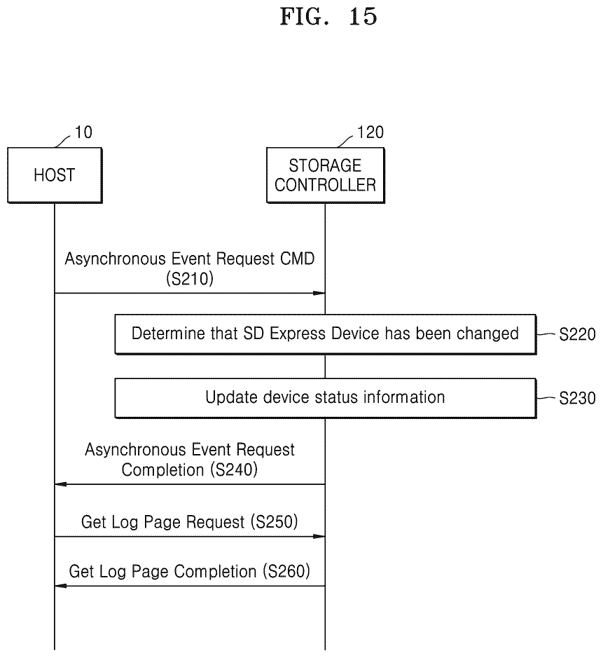

FIG. 15 is a flowchart illustrating an operating method of a storage system according to an embodiment. It is assumed that the first SD Express device 210 is mounted in the first slot 130 and removed during operation.

The operating method of the storage system is described with reference to FIG. 15 when there is a change in which the SD Express device 210 is mounted or removed from the storage device 100 during operation. Referring to FIGS. 1 and 15, in operation S210, the host 10 may transmit an asynchronous event request command (CMD) to the storage controller 120. The asynchronous event request command may be a command having no time-out. When receiving the asynchronous event request command, the storage controller 120 may transmit completion when an event occurs instead of immediately transmitting completion.

After the storage controller 120 receives the asynchronous event request command, the mounted first SD Express device 210 may be removed. In operation S220, the storage controller 120 may determine that the SD Express device 210 has been changed. For example, the storage controller 120 may determine that the first SD Express device 210 is removed from the first slot 130.

In operation S230, the storage controller 120 may update device status information. The storage controller 120 may update the device status information to a log. For example, the storage controller 120 may update information about the number of currently mounted SD Express devices, information about mapping relationships between slots and SD Express devices, and information about mapping relationships between lanes and SD Express devices. Referring to FIG. 1, the log may be stored in the buffer memory 124 of the storage controller 120 and/or NVM devices.

In operation S240, the storage controller 120 may transmit an asynchronous event request completion to inform the host 10 that an event has occurred. For example, the event may indicate a state in which SD Express devices are mounted or the size of storage spaces thereof is changed.

In an embodiment, the asynchronous event request completion may include a log identifier and event type information. The storage controller 120 may read a log updated by the host 10 through the asynchronous event request completion. For example, the log identifier and the event type information may be newly defined in relation to a detachment of SD Express devices (or a change in the size of the storage spaces).

In an embodiment, the storage controller 120 may transmit the asynchronous event request completion including the device status information to the host 1100. In this case, a Get Log Page process described below may not be performed.

In operation S250, the host 10 may transmit a Get Log Page request to the storage controller 120. For example, the log identifier included in a Get Log Page command may indicate a change in SD Express devices.

In operation S260, the storage controller 120 may transmit a Get Log Page completion. The storage controller 120 may write log data to a host memory address included in the Get Log Page command and then transmit the Get Log Page completion.

The above-described embodiment has been described based on when the first SD Express device 210 is removed from the first slot 130, but embodiments are not limited thereto. For example, in some embodiments, when the second SD Express device 220 is mounted in the second slot 140 during operation, the operation of FIG. 15 may be performed.

The storage controller 120 may notify the host 10 that the SD Express devices are mounted or removed or that the size of the storage spaces thereof is changed. That is, the storage controller 120 may notify the host 10 of the state of the SD Express devices and the changed size of the storage spaces. Accordingly, the host 10 may recognize a change in the storage space of the storage device 100 and may be provided with status information of the storage device 100.

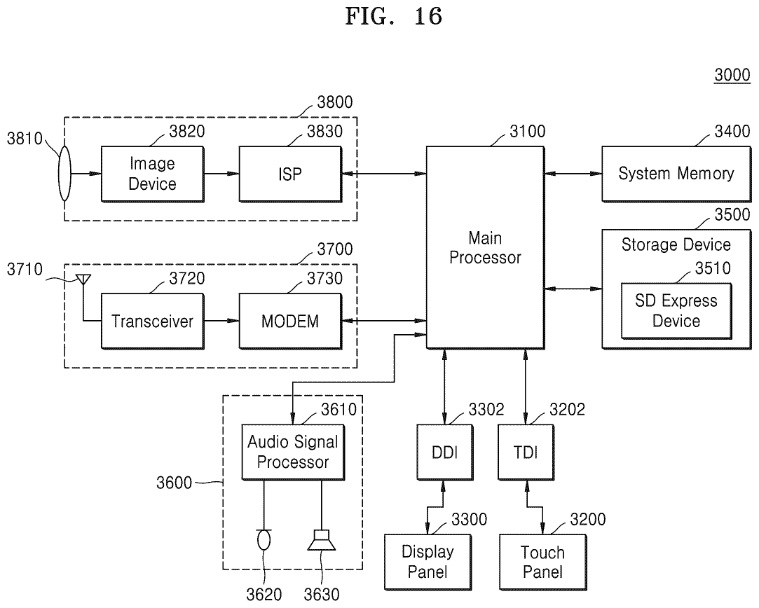

FIG. 16 is a block diagram illustrating an electronic device 3000 according to an embodiment.

Referring to FIG. 16, the electronic device 3000 may include a main processor 3100, a touch panel 3200, a touch driving circuit (TDI) 3202, a display panel 3300, a display driving circuit (DDI) 3302, a system memory 3400, a storage device 3500, an audio processor 3600, a communication block 3700, and an image processor 3800. In some embodiments, the electronic device 3000 may further include a power management circuit. In an embodiment, the electronic device 3000 may be one of various electronic devices such as a mobile communication terminal, a personal digital assistant (PDA), a portable media player (PMP), a digital camera, a smartphone, a tablet computer, a laptop computer, and a wearable device or one of various communication devices supporting wireless communication mediation, such as a wireless router or a wireless communication base station. In an embodiment, the electronic device 3000 may further include components other than those shown in FIG. 16 or some of the components shown in FIG. 16 may be omitted from the electronic device 3000.

The main processor 3100 may control overall operations of the electronic device 3000. The main processor 3100 may control/manage operations of components of the electronic device 3000. The main processor 3100 may process various operations to operate the electronic device 3000.

The touch panel 3200 may be configured to detect a touch input from a user under the control of a touch driving circuit 3202. The display panel 3300 may be configured to display image information under the control of a display driving circuit 3302.

The system memory 3400 may store data used for the operation of the electronic device 3000. For example, the system memory 3400 may include volatile memory such as static random access memory (SRAM), dynamic RAM (DRAM), synchronous DRAM (SDRAM), and/or non-volatile memory such as phase-change RAM (PRAM), magneto-resistive RAM (MRAM), Resistive RAM (ReRAM), ferroelectric RAM (FRAM), etc.

The storage device 3500 may store data regardless of power supply. For example, the storage device 3500 may include at least one of various non-volatile memories such as flash memory, PRAM, MRAM, ReRAM, and FRAM. For example, the storage device 3500 may include a built-in memory and/or a detachable memory of the electronic device 3000. In an embodiment, the storage device 3500 may be the storage device described with reference to FIGS. 1 to 15. The storage device 3500 may include a detachable SD Express device 3510. The storage device 3500 and the SD Express device 3510 may operate based on the operating method described with reference to FIGS. 1 to 15.

The audio processor 3600 may process an audio signal by using an audio signal processor 3610. The audio processor 3600 may receive audio input through a microphone 3620 or provide audio output through a speaker 3630.

The communication block 3700 may exchange signals with an external device/system through an antenna 3710. A transceiver 3720 and a modulator/demodulator (MOMEM) 1730 of the communication block 3700 may process signals exchanged with the external device/system according to at least one of various wireless communication protocols such as Long Term Evolution (LTE), Worldwide Interoperability for Microwave Access (WiMax), Global System for Mobile communication (GSM), Code Division Multiple Access (CDMA), Bluetooth, Near Field Communication (NFC), Wireless Fidelity (Wi-Fi), and Radio Frequency Identification (RFID).

The image processor 3800 may receive light through a lens 3810. An image device 3820 and an image signal processor 3830 included in the image processor 3800 may generate image information about an external object based on the received light.

As described above, the storage device 10 according to an embodiment may include a plurality of detachable SD Express devices. In other words, a micro SD Express card may be mounted in a new form factor of SSD. Accordingly, the user may change the speed and capacity of the storage device 10 according to a selection. As the number of mounted micro SD Express devices increases, the number of lanes used for a host interface connector may increase. The speed of the storage device 10 may increase due to an increase in available PCIe lanes. In addition, in the case of a storage device that does not include a NVM device and includes only a slot of a detachable SD Express device, a process of assembling the NVM device is removed during the manufacturing process, and thus, the manufacturing time may be reduced. Accordingly, the assembly process time may be shortened, and the production volume of the storage device may be increased. In addition, the use of micro SD Express card may be expanded.

While various embodiments have been particularly shown and described with reference to the drawings, it will be understood that various changes in form and details may be made therein without departing from the spirit and scope of the following claims.

What is claimed is:

1. A storage device comprising:
a storage controller; and
a printed circuit board comprising:
a host interface connector comprising a plurality of first pins coupled to an external host device;
a controller socket in which the storage controller is mounted; and
a first slot configured to receive a first secure digital (SD) Express device, the first slot comprising a plurality of second pins to be coupled to the first SD Express device,
wherein a first receive pin among the plurality of first pins is connected to a first receive pin among the plurality of second pins,
a second receive pin among the plurality of first pins is connected to a second receive pin among the plurality of second pins,
a first transmit pin among the plurality of first pins is connected to a first transmit pin among the plurality of second pins, and
a second transmit pin among the plurality of first pins is connected to a second transmit pin among the plurality of second pins.

2. The storage device of claim 1, wherein the first receive pin, the second receive pin, the first transmit pin, and the second transmit pin among the plurality of first pins form a first lane.

3. The storage device of claim 1, further comprising the first SD Express device mounted in the first slot such that the plurality of second pins are coupled to the first SD Express device, the first SD Express device including a plurality of third pins coupled to the first slot,
wherein a first receive pin among the plurality of third pins is coupled to the first receive pin among the plurality of second pins,
a second receive pin among the plurality of third pins is coupled to the second receive pin among the plurality of second pins,
a first transmit pin among the plurality of third pins is coupled to the first transmit pin among the plurality of second pins, and
a second transmit pin among the plurality of third pins is coupled to the second transmit pin among the plurality of second pins.

4. The storage device of claim 3, wherein the first SD Express device is configured to receive a request or data from the external host device through the first receive pin among the plurality of third pins and the second receive pin among the plurality of third pins, and transmit data or a response to the external host device through the first transmit pin among the plurality of third pins and the second transmit pin among the plurality of third pins.

5. The storage device of claim 3, wherein the storage controller is configured to receive a detection signal from the first SD Express device and transmit an identification command to the first SD Express device based on the detection signal.

6. The storage device of claim 3, wherein the storage controller is configured to update device status information when the first SD Express device is removed from the first slot.

7. The storage device of claim 3, further comprising:
a second slot configured to receive a second SD Express device, the second slot including a plurality of fourth pins to be coupled to the second SD Express device,
wherein a third receive pin among the plurality of first pins is connected to a first receive pin among the plurality of fourth pins,
a fourth receive pin among the plurality of first pins is connected to a second receive pin among the plurality of fourth pins,
a third transmit pin among the plurality of first pins is connected to a first transmit pin among the plurality of fourth pins,
a fourth transmit pin among the plurality of first pins is connected to a second transmit pin among the plurality of fourth pins,
the first receive pin, the second receive pin, the first transmit pin, and the second transmit pin among the plurality of first pins form a first lane, and
the third receive pin, the fourth receive pin, the third transmit pin, and the fourth transmit pin among the plurality of first pins form a second lane.

8. The storage device of claim 7, further comprising the second SD Express device mounted in the second slot such that the plurality of fourth pins are coupled to the second SD Express device, and the second SD Express device including a plurality of fifth pins coupled to the second slot,
wherein a first receive pin among the plurality of fifth pins is coupled to the first receive pin among the plurality of fourth pins,
a second receive pin among the plurality of fifth pins is coupled to the second receive pin among the plurality of fourth pins,
a first transmit pin among the plurality of fifth pins is coupled to the first transmit pin among the plurality of fourth pins, and
a second transmit pin among the plurality of fifth pins is coupled to the second transmit pin among the plurality of fourth pins.

9. The storage device of claim 8, wherein the first slot is disposed on a top surface of the printed circuit board, and the second slot is disposed on a bottom surface of the printed circuit board.

10. The storage device of claim 8, wherein the first slot is disposed on one side of the printed circuit board, and the second slot is disposed on a same surface as the first slot.

11. The storage device of claim 8, wherein each of the first SD Express device and the second SD Express device conform to a micro SD Express card standard.

12. The storage device of claim 8, wherein the storage device is configured to support a hot-plug function capable of mounting or removing the first SD Express device in or from the first slot, and capable of mounting or removing the second SD Express device in or from the second slot.

13. The storage device of claim 1, wherein the host interface connector is implemented based on a U.2 form factor, an M.2 form factor, or a Peripheral Component Interconnect Express (PCIe)-based form factor.

14. The storage device of claim 1, further comprising a non-volatile memory device connected to transmit and receive data under control of the storage controller,
wherein the non-volatile memory device is built-in the storage device and is not detachable from the storage device.

15. The storage device of claim 14, further comprising the first SD Express device mounted in the first slot,
wherein the non-volatile memory device is configured to receive and store data provided from the external host device through the storage controller, and
the first SD Express device is configured to directly receive and store the data provided from the external host device.

16. A storage device comprising:
a storage controller;
a host interface connector comprising a plurality of first pins coupled to an external host device;
a first slot configured to receive a first secure digital (SD) Express device, the first slot comprising a plurality of second pins to be coupled to the first SD Express device;
a first signal line configured to connect a first receive pin among the plurality of first pins to a first receive pin among the plurality of second pins;
a second signal line configured to connect a second receive pin among the plurality of first pins to a second receive pin among the plurality of second pins;
a third signal line configured to connect a first transmit pin among the plurality of first pins to a first transmit pin among the plurality of second pins; and
a fourth signal line configured to connect a second transmit pin among the plurality of first pins to a second transmit pin among the plurality of second pins.

17. The storage device of claim 16, further comprising the first SD Express device mounted in the first slot and including a plurality of third pins coupled to the first slot,
wherein a first receive pin among the plurality of third pins is coupled to the first receive pin among the plurality of second pins,
a second receive pin among the plurality of third pins is coupled to the second receive pin among the plurality of second pins,
a first transmit pin among the plurality of third pins is coupled to the first transmit pin among the plurality of second pins, and
a second transmit pin among the plurality of third pins is coupled to the second transmit pin among the plurality of second pins.

18. The storage device of claim 16, wherein the storage device is configured to support a hot-plug function capable of mounting the first SD Express device in the first slot or removing the first SD Express device from the first slot.

19. The storage device of claim 16, wherein the host interface connector is implemented based on a U.2 form factor, an M.2 form factor, or a Peripheral Component Interconnect Express (PCIe)-based form factor.

20. A storage device comprising:
a storage controller;
a first secure digital (SD) Express device;
a second SD Express device;
a non-volatile memory device; and
a printed circuit board comprising:
a host interface connector comprising a plurality of first pins coupled to an external host device;
a controller socket in which the storage controller is mounted;
a memory socket in which the non-volatile memory device is mounted;
a first slot in which the first SD Express device is mounted, the first slot comprising a plurality of second pins coupled to the first SD Express device; and
a second slot in which the second SD Express device is mounted, the second slot comprising a plurality of third pins coupled to the second SD Express device,
wherein:
a first receive pin among the plurality of first pins is connected to a first receive pin among the plurality of second pins,
a second receive pin among the plurality of first pins is connected to a second receive pin among the plurality of second pins,
a first transmit pin among the plurality of first pins is connected to a first transmit pin among the plurality of second pins,
a second transmit pin among the plurality of first pins is connected to a second transmit pin among the plurality of second pins,
a third receive pin among the plurality of first pins is connected to a first receive pin among the plurality of third pins,
a fourth receive pin among the plurality of first pins is connected to a second receive pin among the plurality of third pins,
a third transmit pin among the plurality of first pins is connected to a first transmit pin among the plurality of third pins, and
a fourth transmit pin among the plurality of first pins is connected to a second transmit pin among the plurality of third pins.
